(19) United States
(12) Patent Application Publication
(10) Pub. No.: US 2014/0153485 A1
(43) Pub. Date: Jun. 5, 2014

(54) INFORMATION PROCESSING APPARATUS, COMMUNICATION SYSTEM, INFORMATION PROCESSING METHOD, AND PROGRAM

(71) Applicant: Sony Corporation, Tokyo (JP)

(72) Inventor: Shinichiro Tsuda, Kanagawa (JP)

(73) Assignee: Sony Corporation, Tokyo (JP)

(21) Appl. No.: 14/086,657

(22) Filed: Nov. 21, 2013

(30) Foreign Application Priority Data
Nov. 30, 2012 (JP) 2012-262574

(51) Int. Cl. H04W 36/32; H04W 24/02

(52) U.S. Cl. CPC H04W 36/32; H04W 24/02
USPC 370/328

(57) ABSTRACT

There is provided an information processing apparatus including a determining unit that determines a movement state of a wireless communication apparatus, and a control unit that restricts a base station selection process of the wireless communication apparatus, on the basis of the determined movement state.

### CROSS REFERENCE TO RELATED APPLICATIONS

This application claims the benefit of Japanese Priority Patent Application JP 2012-262574 filed Nov. 30, 2012, the entire contents of which are incorporated herein by reference.

### BACKGROUND

The present disclosure relates to an information processing apparatus and more particularly, to an information processing apparatus, a communication system, and an information processing method that perform wireless communication and a program for causing a computer to execute the information processing method.

In the related art, a wireless communication apparatus that is connected to a network such as a public wireless network has spread widely. A mobile phone service of a 3G (3rd Generation) method (in Japan, referred to as the third-generation mobile phone service) has started in 2002. As the mobile phone service, initially, applications using packets having a small capacity size such as a sound and an e-mail are mainly used. However, use aspects of users change to downloading of packets having a relatively large capacity size such as download of a music file or viewing of a moving image, by introducing HSDPA (High Speed Downlink Packet Access) or the like.

For example, the case in which users are concentrated in a specific area and download packets having a large capacity size is assumed. In this case, because traffic is locally concentrated, a sufficient rate may not be obtained.

Therefore, technology of handover to switch a base station using communication quality has been suggested (for example, Japanese Patent Application Laid-Open (JP-A) No. 2011-176722).

### SUMMARY

In the related art, the handover can be appropriately executed using the communication quality.

Here, a base station where a cell size (coverage) is relatively small or a base station where a cell size is relatively large exists as a base station connected when wireless communication is used. In addition, a high-speed communication system (for example, long term evolution (LTE)) generally provides a service with a relatively small cell size.

For example, the case in which a wireless communication apparatus where switching of a 3G system and an LTE system is enabled moves at a high speed (for example, movement by an electric train) is assumed. In this case, as described above, because the high-speed communication system has the relatively small cell size, it is assumed that processes such as handover, cell selection, and cell reselection are repeated frequently between the 3G system and the LTE system. As such, if each process is continuously executed for a long time, overhead of the wireless communication increases. As a result, the throughput (or the communication capacity) may be decreased.

It is desirable to appropriately perform control regarding a base station selection process.

According to a first embodiment of the present disclosure, there is provided an information processing apparatus including a determining unit that determines a movement state of a wireless communication apparatus, and a control unit that restricts a base station selection process of the wireless communication apparatus, on the basis of the determined movement state. Thereby, the base station selection process of the wireless communication apparatus may be restricted on the basis of the determined movement state.

According to the first embodiment of the present disclosure, the determining unit may determine a type of a movement mechanism of the wireless communication apparatus, and the control unit may restrict the base station selection process, on the basis of the determined type of the movement mechanism. Thereby, the base station selection process may be restricted on the basis of the determined type of the movement mechanism.

According to the first embodiment of the present disclosure, the control unit may restrict the base station selection process, only when the determined type of the movement mechanism is a high-speed movement mechanism. Thereby, the base station selection process may be restricted only when the determined type of the movement mechanism is the high-speed movement mechanism.

According to the first embodiment of the present disclosure, the determining unit may determine whether the high-speed movement mechanism is in a stop state, and the control unit does not necessarily restrict the base station selection process, when the high-speed movement mechanism is in a stop state even though the determined type of the movement mechanism is the high-speed movement mechanism. Thereby, the base station selection process may not be restricted when the high-speed movement mechanism is in a stop state even though the determined type of the movement mechanism is the high-speed movement mechanism.

According to the first embodiment of the present disclosure, the control unit may restrict the base station selection process, when a connection state of a specific communication service at a position where the high-speed movement mechanism exists satisfies a predetermined condition even though the determined type of the movement mechanism is the high-speed movement mechanism and the high-speed movement mechanism is in a stop state. Thereby, the base station selection process may be restricted when the connection state of the specific communication service at the position where the high-speed movement mechanism exists satisfies the predetermined condition even though the determined type of the movement mechanism is the high-speed movement mechanism and the high-speed movement mechanism is in a stop state.

According to the first embodiment of the present disclosure, the information processing apparatus may further include a specifying unit that specifies a movement path of the wireless communication apparatus, on the basis of position information regarding the wireless communication apparatus. The control unit may restrict the base station selection process, on the basis of the determined type of the movement mechanism and the specified movement path. Thereby, the base station selection process may be restricted on the basis of the determined type of the movement mechanism and the specified movement path.

According to the first embodiment of the present disclosure, the control unit may restrict the base station selection process, only when the determined type of the movement mechanism is a high-speed movement mechanism and the number of times of switching between different communication methods in the specified movement path is large on the basis of a predetermined value. Thereby, the base station selection process may be restricted only when the determined type of the movement mechanism is the high-speed movement mechanism and the number of times of switching between the different communication methods in the specified movement path is large on the basis of the predetermined value.

According to the first embodiment of the present disclosure, the control unit does not necessarily restrict the base station selection process, when a specific communication service is provided in the high-speed movement mechanism even though the determined type of the movement mechanism is the high-speed movement mechanism. Thereby, the base station selection process may not be restricted when the specific communication service is provided in the high-speed movement mechanism even though the determined type of the movement mechanism is the high-speed movement mechanism.

According to the first embodiment of the present disclosure, the control unit may restrict each process regarding handover, cell selection, and cell reselection between different communication methods as the restriction of the base station selection process and executes only each process regarding handover, cell selection, and cell reselection between the same communication methods. Thereby, each process regarding the handover, the cell selection, and the cell reselection between the different communication methods may be restricted and only each process regarding the handover, the cell selection, and the cell reselection between the same communication methods may be executed.

According to the first embodiment of the present disclosure, the control unit may restrict switching from a communication method in which a cell size is large to a communication method in which a cell size is small as the restriction of the base station selection process and executes only each process regarding handover, cell selection, and cell reselection between the same communication methods. Thereby, the switching from the communication method in which the cell size is large to the communication method in which the cell size is small may be restricted and only each process regarding the handover, the cell selection, and the cell reselection between the same communication methods may be executed.

According to a second embodiment of the present disclosure, there is provided an information processing apparatus, an information processing method and a program causing a computer to execute the program, the information processing apparatus including a specifying unit that specifies a movement path of a wireless communication apparatus, on the basis of position information regarding the wireless communication apparatus, and a control unit that associates the specified movement path and the position information regarding the wireless communication apparatus in the specified movement path and displays an association result on the wireless communication apparatus. Thereby, the specified movement path and the position information regarding the wireless communication apparatus in the specified movement path may be associated and the association result may be displayed on the wireless communication apparatus.

According to a third embodiment of the present disclosure, there is a communication system, an information processing method of the same and a program causing a computer to execute the method, the communication system including an information processing apparatus that includes a determining unit that determines a movement state of a wireless communication apparatus and a control unit that performs control to restrict a base station selection process of the wireless communication apparatus, on the basis of the determined movement state, and a wireless communication apparatus in which the base station selection process is restricted on the basis of control by the information processing apparatus. Thereby, the information processing apparatus may perform control to restrict the base station selection process of the wireless communication apparatus, on the basis of the determined movement state. In the wireless communication apparatus, the base station selection process may be restricted on the basis of the control by the information processing apparatus.

According to the embodiments of the present disclosure described above, control regarding a base station selection process can be appropriately performed.

### BRIEF DESCRIPTION OF THE DRAWINGS

FIG. 1 is a block diagram illustrating a functional configuration example of a wireless communication apparatus 100 according to a first embodiment of the present disclosure;

FIG. 2 is a diagram schematically illustrating control content of a control unit 150 according to the first embodiment of the present disclosure;

FIG. 3 is a diagram illustrating an example (setting screen 190) of a setting screen that is displayed on a display unit 170 according to the first embodiment of the present disclosure;

FIG. 4 is a flowchart illustrating an example of a process sequence of a base station selection process control process of the wireless communication apparatus 100 according to the first embodiment of the present disclosure;

FIG. 5 is a flowchart illustrating an example of a movement type determination process sequence of the base station selection process control process of the wireless communication apparatus 100 according to the first embodiment of the present disclosure;

FIG. 6 is a block diagram illustrating a functional configuration example of a communication system 200 according to a second embodiment of the present disclosure;

FIG. 7 is a block diagram illustrating functional configuration examples of an information processing apparatus 210 and a wireless communication apparatus 240 according to the second embodiment of the present disclosure;

FIG. 8 is a sequence chart illustrating an example of a communication process between individual apparatuses constituting the communication system 200 according to the second embodiment of the present disclosure;

FIG. 9 is a block diagram illustrating a functional configuration example of a wireless communication apparatus 300 according to a third embodiment of the present disclosure;

FIG. 10 is a diagram illustrating a map including a part of each spot of which each information is stored in a spot information storage unit 310 according to the third embodiment of the present disclosure;

FIG. 11 is a diagram schematically illustrating an example of storage content of the spot information storage unit 310 according to the third embodiment of the present disclosure;

FIG. 12 is a diagram schematically illustrating an example of storage content of a section information storage unit 340 according to the third embodiment of the present disclosure;

FIG. 13 is a diagram schematically illustrating an example of a method of setting position information stored in the section information storage unit 340 according to the third embodiment of the present disclosure;

FIG. 14 is a diagram schematically illustrating an example of storage content of a base station information storage unit 380 according to the third embodiment of the present disclosure;

FIG. 15 is a flowchart illustrating an example of a process sequence of a base station selection process control process of the wireless communication apparatus 300 according to the third embodiment of the present disclosure;

FIG. 16 is a diagram illustrating an example of each area in the case in which spot information stored in a spot information storage unit 390 according to the third embodiment of the present disclosure is managed in an area unit;

FIG. 17 is a diagram schematically illustrating an example of storage content of a section information storage unit 430 according to the third embodiment of the present disclosure;

FIG. 18 is a diagram schematically illustrating an example of storage content of a spot information storage unit 440 according to the third embodiment of the present disclosure;

FIG. 19 is a block diagram illustrating a functional configuration example of an information processing apparatus 500 according to a fourth embodiment of the present disclosure;

FIG. 20 is a block diagram illustrating a functional configuration example of a control terminal managing unit 530 according to the fourth embodiment of the present disclosure;

FIG. 21 is a sequence chart illustrating an example of a communication process between individual apparatuses constituting a communication system 200 according to the fourth embodiment of the present disclosure;

FIG. 22 is a sequence chart illustrating an example of a communication process between individual apparatuses constituting the communication system 200 according to the fourth embodiment of the present disclosure;

FIG. 23 is a sequence chart illustrating an example of a communication process between individual apparatuses constituting the communication system 200 according to the fourth embodiment of the present disclosure;

FIG. 24 is a flowchart illustrating an example of a process sequence of a base station selection process control process of the information processing apparatus 500 according to the fourth embodiment of the present disclosure;

FIG. 25 is a block diagram illustrating a functional configuration example of a wireless communication apparatus 700 according to a fifth embodiment of the present disclosure;

FIG. 26 is a diagram schematically illustrating an example of storage content of an association information storage unit 730 according to the fifth embodiment of the present disclosure;

FIG. 27 is a diagram illustrating an example (display screen 760) of a display screen that is displayed on a display unit 170 according to the fifth embodiment of the present disclosure;

FIG. 28 is a flowchart illustrating an example of a process sequence of a display process of the wireless communication apparatus 700 according to the fifth embodiment of the present disclosure;

FIG. 29 is a block diagram illustrating a functional configuration example of an information processing apparatus 800 according to a sixth embodiment of the present disclosure;

FIG. 30 is a diagram schematically illustrating an example of storage content of an association information storage unit 801 according to the sixth embodiment of the present disclosure; and

FIG. 31 is a diagram schematically illustrating an example of storage content of a linking information storage unit 805 according to the sixth embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

1. First embodiment (base station selection process control: example of case in which type of movement mechanism is determined in wireless communication apparatus and base station selection process is restricted on the basis of determination result)
2. Second embodiment (base station selection process control: example of case in which type of movement mechanism of wireless communication apparatus is determined in information processing apparatus and base station selection process of wireless communication apparatus is restricted on the basis of determination result)
3. Third embodiment (base station selection process control: example of case in which determination of type of movement mechanism of wireless communication apparatus and specification of movement path of wireless communication apparatus are performed and base station selection process of wireless communication apparatus is restricted on the basis of result thereof)
4. Fourth embodiment (base station selection process control: example of case in which determination of type of movement mechanism or specification of movement path is performed in information processing apparatus and base station selection process of wireless communication apparatus is restricted on the basis of result thereof)
5. Fifth embodiment (display control: example of case in which various information regarding movement path of wireless communication apparatus is displayed)
6. Sixth embodiment (display control: example of case in which association of each information is performed in information processing apparatus and association information thereof is displayed on wireless communication apparatus)

### 1. First Embodiment

### [Configuration Example of Wireless Communication Apparatus]

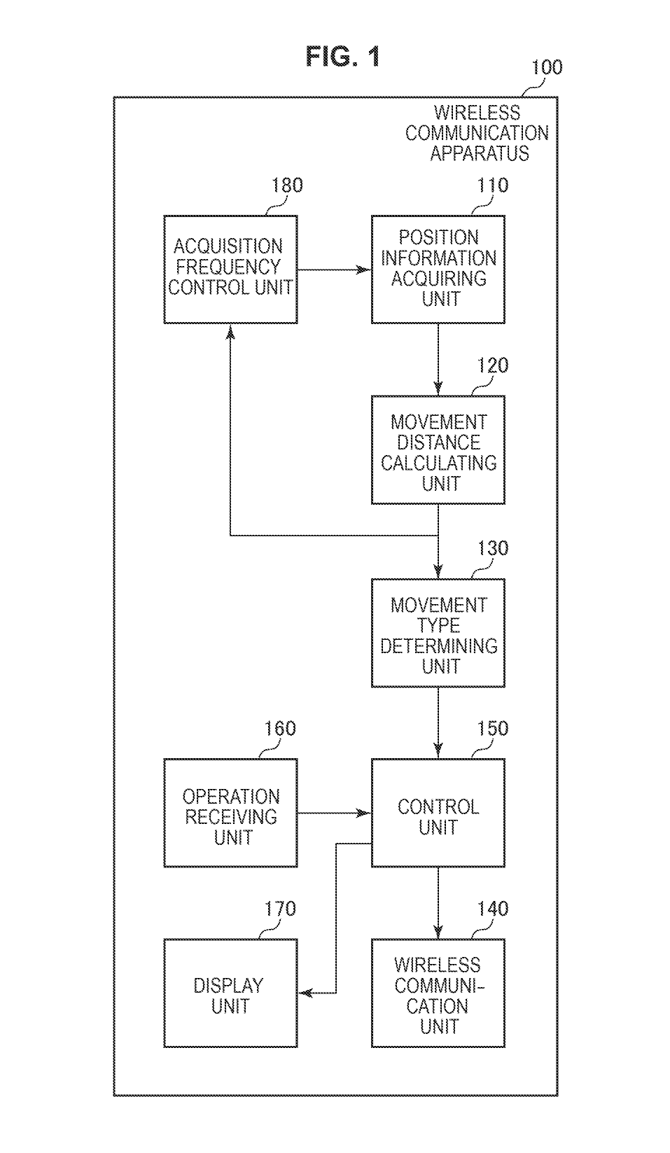

FIG. 1 is a block diagram illustrating a functional configuration example of a wireless communication apparatus 100 according to a first embodiment of the present disclosure.

The wireless communication apparatus 100 includes a position information acquiring unit 110, a movement distance calculating unit 120, a movement type determining unit 130, a wireless communication unit 140, a control unit 150, a operation receiving unit 160, a display unit 170, and an acquisition frequency control unit 180. The wireless communication apparatus 100 is a mobile phone (for example, a mobile phone or a smart phone having a calling function and a data communication function) or a data communication apparatus (for example, a personal computer) including a wireless communication function. The wireless communication apparatus 100 is an example of a wireless communication apparatus and an information processing apparatus according to an embodiment of the present disclosure.

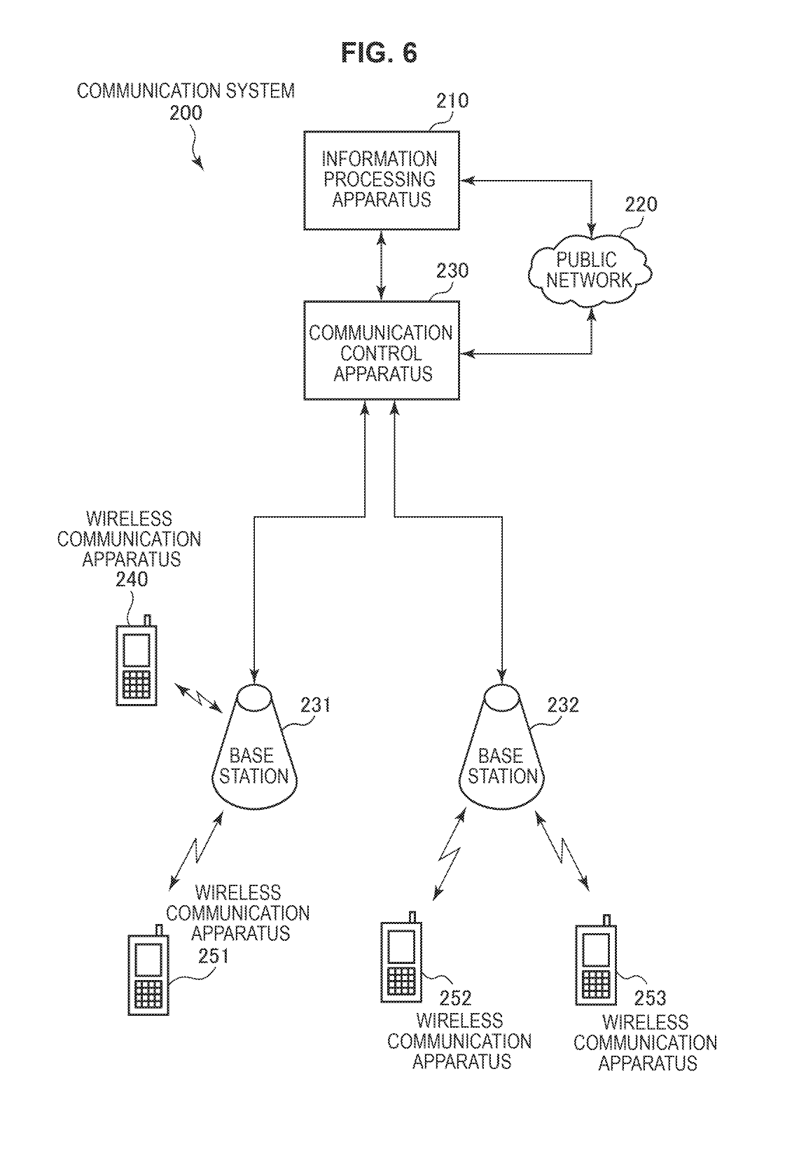

The position information acquiring unit 110 acquires information (position information (for example, a latitude, a longitude, and an altitude)) to specify a position (location position) where the wireless communication apparatus 100 exists, with a fixed or varied period. In addition, the position information acquiring unit 110 outputs the acquired position information to the movement distance calculating unit 120. The position information acquiring unit 110 is realized by, for example, a global positioning system (GPS) receiver that receives a GPS signal and calculates a latitude, a longitude, and an altitude. In addition, the position information acquiring unit 110 may acquire the position information from an information processing apparatus (for example, a communication control apparatus (for example, a communication control apparatus 230 illustrated in FIG. 6) managed by a carrier regarding contract authentication information set at the present time), through the wireless communication unit 140. For example, the position information acquiring unit 110 can acquire information (position information) regarding a position corresponding to identification information of a base station of a wireless communication apparatus (for example, a mobile phone) or an access point of a wireless local area network (LAN) from other information processing apparatus. The identification information of the base station is, for example, a cell identifier (ID) and the identification information of the access point of the wireless LAN is, for example, a service set identifier (SSID).

The contract authentication information is information necessary for connection to a wireless communication network managed by the carrier and includes, for example, contractor information regarding authentication or charging. In addition, the contract authentication information includes subscriber information of the mobile phone and authentication key (authentication) information. For example, the contract authentication information is a universal subscriber identity module (USIM).

The movement distance calculating unit 120 calculates a movement distance of the wireless communication apparatus 100, on the basis of the position information acquired by the position information acquiring unit 110, and outputs the calculated movement distance to the movement type determining unit 130 and the acquisition frequency control unit 180. For example, the movement distance calculating unit 120 uses position information acquired at two times (for example, an interval of one minute) different in time series among the position information acquired by the position information acquiring unit 110 to calculate a movement distance (for example, a movement distance per minute (unit time)) between the position information.

The movement type determining unit 130 determines a type of a movement mechanism of a user of the wireless communication apparatus 100, on the basis of the movement distance calculated by the movement distance calculating unit 120, and outputs a determination result to the control unit 150. For example, the movement type determining unit 130 determines a type of a movement mechanism such as a walk, a bicycle, a bus, and an electric train, on the basis of the movement distance per unit time calculated by the movement distance calculating unit 120.

For example, when a movement distance per minute is less than 100 m, the movement type determining unit 130 determines that the movement mechanism of the user is the “walk”. When the movement distance per minute is equal to or more than 100 m and is less than 250 m, the movement type determining unit 130 determines that the movement mechanism of the user is the “bicycle”. When the movement distance per minute is equal to or more than 250 m and is less than 650 m, the movement type determining unit 130 determines that the movement mechanism of the user is the “bus”. When the movement distance per minute is equal to or more than 650 m, the movement type determining unit 130 determines that the movement mechanism of the user is the “electric train”. The movement type determining unit 130 may determine the type of the movement mechanism, on the basis of an average value (average movement distance) of movement distances (movement distances per minute) calculated by the movement distance calculating unit 120.

The movement type determining unit 130 may determine the type of the movement mechanism, on the basis of a maximum speed, instead of the movement distance or the average movement distance. For example, when the maximum speed is less than 5 km/h, the movement type determining unit 130 can determine the movement mechanism as the “walk” and when the maximum speed is equal to or more than 5 km/h and is less than 30 km/h, the movement type determining unit 130 can determine the movement mechanism as the “bicycle”. For example, when the maximum speed is equal to or more than 30 km/h and is less than 60 km/h, the movement type determining unit 130 can determine the movement mechanism as the “bus” and when the maximum speed is equal to or more than 60 km/h, the movement type determining unit 130 can determine the movement mechanism as the “electric train”. In addition, the movement type determining unit 130 may widen the type of the movement mechanism as “the walk or the bicycle”, “the bicycle or the bus”, and “the bus or the electric train”, on the basis of the movement distance, the average movement distance, and the maximum speed, and may raise determination precision.

A feature of each movement mechanism of the walk, the bicycle, the bus, and the electric train may be extracted on the basis of the acquisition history of an acceleration sensor normally mounted to a large number of smart phones and the type of the movement mechanism may be determined on the basis of the feature of the acceleration sensor acquired at each time.

Here, when the determination process described above is executed, a state in which the electric train stops at a station may be erroneously determined as the “walk”. Therefore, in order to prevent the state in which the electric train stops at the station from being erroneously determined as the “walk”, when the average movement distance per minute is less than 100 m, the number of times of being determined as “less than 100 m” may be counted. In addition, only when a count number becomes equal to or more than a threshold value, the type of the movement mechanism is determined as the “walk” and when the count number is less than the threshold value, the type of the movement mechanism is not determined as the “walk” and the determination process is repetitively executed. Thereby, the possibility of the state in which the electric train stops at the station being erroneously determined as the “walk” can be decreased. The count process may be executed only when the type of the movement mechanism is the “bus” or the “electric train”.

In addition, a state in which a high-speed movement mechanism (for example, the electric train) stops while the user uses the high-speed movement mechanism can be determined as “the high-speed movement mechanism is in a stop state”. For example, a state in which the electric train stops at the station when the user gets on the electric train can be determined as “the electric train is in a stop state”. For example, after the type of the movement mechanism of the wireless communication apparatus 100 is determined as the high-speed movement mechanism, the process (process for counting the number of times of being determined as “less than 100 m”) regarding the “walk” is not executed and it is determined whether “the high-speed movement mechanism is in a stop state”. For example, in the case in which the average movement distance per minute is less than 100 m, when the most recently determined movement mechanism is the high-speed movement mechanism, it can be determined that the high-speed movement mechanism is in a stop state”. However, the case in which the user who has got on the electric train walks from the station is also assumed. Therefore, even in the case in which the average movement distance per minute is less than 100 m and the most recently determined movement mechanism is the high-speed movement mechanism, when the user moves the distance of the threshold value or more after it is determined that “the high-speed movement mechanism is in a stop state”, the type of the movement mechanism may be determined as the “walk”. As the threshold value, for example, 100 to 300 (m) may be used.

As such, the movement type determining unit 130 determines a movement state (for example, a high-speed movement and a low-speed movement) of the wireless communication apparatus 100. In addition, when the type of the movement mechanism of the wireless communication apparatus 100 is the high-speed movement mechanism, the movement type determining unit 130 determines whether the high-speed movement mechanism is in a stop state. The movement type determining unit 130 is an example of a determining unit according to an embodiment of the present disclosure.

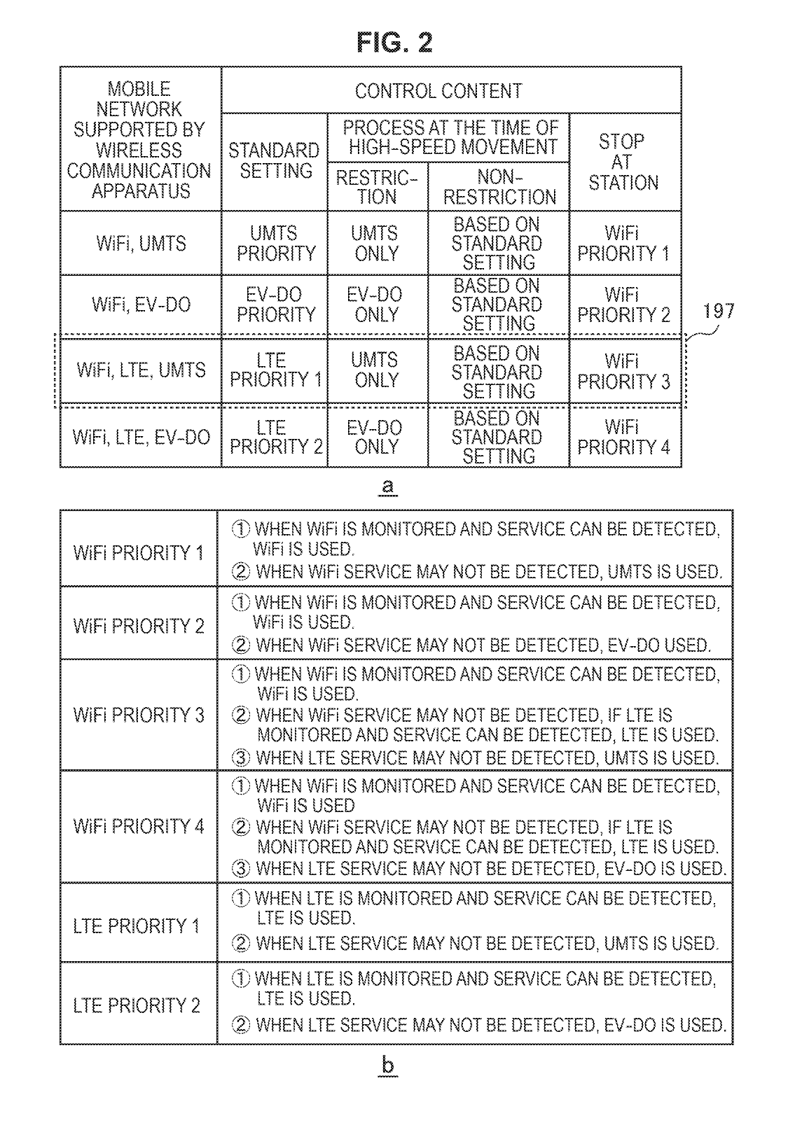

The wireless communication unit 140 is a wireless communication unit that includes a receiving unit receiving a radio signal transmitted from each base station and a transmitting unit transmitting a radio signal to each base station and corresponds to a plurality of wireless communication services (communication system). The wireless communication services to which the wireless communication unit 140 can correspond are wireless communication services (mobile network) illustrated in a of FIG. 2. For example, the wireless communication services to which the wireless communication unit 140 corresponds are WiFi (Wireless Fidelity) and UMTS (Universal Mobile Telecommunications System). For example, the wireless communication services to which the wireless communication unit 140 corresponds are the WiFi and EV-DO (Evolution Data Only (Optimized)). For example, the wireless communication services to which the wireless communication unit 140 corresponds are the WiFi, LTE (Long Term Evolution), and the UMTS. For example, the wireless communication services to which the wireless communication unit 140 corresponds are the WiFi, the LTE, and the EV-DO. As such, the wireless communication unit 140 can be connected to a plurality of base stations (for example, a base station of the WiFi and a base station of the UMTS) having different communication methods. In addition, connection switching with each base station (base station selection process) is performed on the basis of control of the control unit 150. A base station selection process means each process regarding handover, cell selection, and cell reselection. In addition, the UMTS and the EV-DO are an example of a 3G system.

Here, a cell size (coverage) of the base station that is connected when wireless communication is used will be described. Generally, a cell size of a femtocell is 100 m to 200 m in a radius and a cell size of a picocell is 250 m to 500 m in a radius. In addition, generally, a cell size of a microcell is 1 km to 3 km in a radius and a cell size of a macrocell is 1 km to 25 km in a radius. The high-speed communication system (for example, the LTE and the WiFi) generally provides a service with a relatively small cell size.

Here, the case in which a wireless communication apparatus in which switching of the 3G system (for example, the UMTS or the EV-DO) and the LTE system is enabled moves at a high speed (for example, the case in which the wireless communication apparatus moves by the electric train) is assumed. That is, the case in which the wireless communication apparatus satisfies a condition in which mobility is high is assumed. In this case, as described above, because the LTE system (high-speed communication system) has a relatively small cell size, it is assumed that the processes such as the handover, the cell selection, and the cell reselection are repeated frequently between the 3G system and the LTE system. However, if each process is continuously executed for a long time, overhead of the wireless communication increases. As a result, the throughput (or the communication capacity) may be decreased.

Therefore, in the embodiment of the present disclosure, under the condition in which the mobility is high (when the wireless communication apparatus is moving at a high speed (for example, when the wireless communication apparatus is moving by the electric train)), restrictions are put to execute only the processes such as the handover, the cell selection, and the cell reselection between the same communication systems in which service regions of cell sizes are large. That is, a base station selection process is restricted. Here, the communication system in which the service region of the cell size is large is, for example, the 3G system. Meanwhile, under a condition in which the mobility is low (for example, during the walk or stop at the station), the restriction is released and the processes such as the handover, the cell selection, and the cell reselection between different communication systems are permitted. For example, the processes such as the handover, the cell selection, and the cell reselection between the 3G system and the LTE system are appropriately executed according to a communication situation of the wireless communication apparatus. The system that provides services with a small cell is not limited to the LTE and includes other communication system (for example, the WiFi).

In addition, a service of the 3G system based on the femtocell may be handled as a service provided with a small cell. For example, between the 3G systems using the femtocell, under the condition in which the mobility is high, only the base station selection process for the base stations other than the femtocell may be permitted and the base station selection process with respect to the femtocell may be restricted. That is, between the 3G systems using a base station having a relatively large cell size and a base station having a relatively small cell size, only the base station selection process with respect to the base station having the relatively large cell size may be permitted and the base station selection process with respect to the femtocell may be restricted. When the femtocell is identified, identification information included in information provided from the base station may be used and base station identification information (for example, a cell ID) of the femtocell may be provided to the wireless communication apparatus 100 in a form of a database. When the base station selection process is restricted, a power supply of a reception circuit to scan other communication system (for example, the WiFi) may be made not to be turned on.

In addition, the case in which the 3G and the LTE use the same band is also assumed. For this reason, in the embodiment of the present disclosure, switching to a different communication system includes the meaning of the switching to the different communication system, regardless of a frequency.

The control unit 150 controls the base station selection process in the wireless communication unit 140, on the basis of a determination result by the movement type determining unit 130.

For example, the control unit 150 performs control to restrict the base station selection process in the wireless communication unit 140, on the basis of a movement state (for example, a high-speed movement state or a stop state) determined by the movement type determining unit 130. In other words, the control unit 150 restricts the base station selection process, on the basis of the type of the movement mechanism determined by the movement type determining unit 130. In this case, the control unit 150 restricts the base station selection process only when the determined type of the movement mechanism is the high-speed movement mechanism (or when the wireless communication apparatus 100 is moving at a high speed). Here, methods of restricting the base station selection process may include a method of turning off a power supply of a reception circuit performing intermittent reception to receive information from the base station during only a restriction period (for example, a method of stopping an intermittent reception operation of the LTE). The determination of the type (for example, the high-speed movement state or the stop state) of the movement mechanism may be performed on the basis of the number of times of changing a cell ID in most recent one minute.

As such, the control unit 150 can restrict each process regarding the handover, the cell selection, and the cell reselection between different communication methods as the restriction of the base station selection process and execute only each process regarding the handover, the cell selection, and the cell reselection between the same communication methods. In addition, the control unit 150 can restrict switching from a communication method of a large cell size to a communication method of a small cell size as the restriction of the base station selection process and execute only each process regarding the handover, the cell selection, and the cell reselection between the same communication methods.

The operation receiving unit 160 is an operation receiving unit to receive an operation input operated by the user and outputs a signal according to the received operation input to the control unit 150. The operation receiving unit 160 includes various keys such as a figure key or an alphabet key.

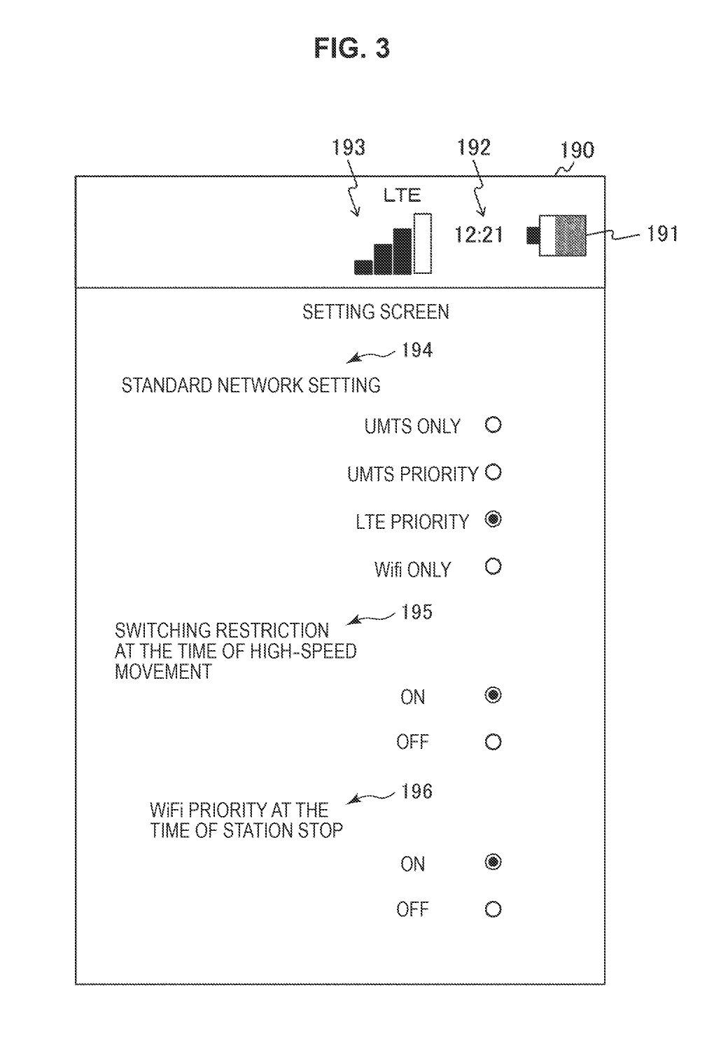

The display unit 170 is a display unit that displays various information (such as character information or time information), on the basis of control of the control unit 150. For example, the display unit 170 displays a setting screen (for example, a setting screen 190 illustrated in FIG. 3) to perform setting regarding communication. As the display unit 170, a display panel such as an organic electro luminescence (EL) panel and a liquid crystal display (LCD) panel can be used. The operation receiving unit 160 and the display unit 170 can be configured integrally using a touch panel in which the user can make a finger contact or approach a display surface and perform an operation input.

The acquisition frequency control unit 180 controls the acquisition frequency of the position information by the position information acquiring unit 110, on the basis of the movement distance calculated by the movement distance calculating unit 120. For example, when the movement distance calculating unit 120 calculates the movement distance per minute as the distance less than 100 m, the acquisition frequency control unit 180 sets the acquisition frequency of the position information by the position information acquiring unit 110 to 5 minutes. For example, when the movement distance calculating unit 120 calculates the movement distance per minute as the distance equal to or more than 500 m, the acquisition frequency control unit 180 sets the acquisition frequency of the position information by the position information acquiring unit 110 to one minute. When the movement distance calculating unit 120 calculates the movement distance per minute as the distance equal to or more than 100 m and less than 500 m, the acquisition frequency control unit 180 sets the acquisition frequency of the position information by the position information acquiring unit 110 to 3 minutes. The setting of the acquisition frequency of the position information by the acquisition frequency control unit 180 is not limited to three steps and may be set to two steps or four steps or more. When the high-speed movement mechanism is being used, the determination process of “the high-speed movement mechanism is in a stop state” is executed even though the movement distance per minute is less than 100 m. For this reason, the acquisition frequency of the position information by the position information acquiring unit 110 may be set high (for example, one minute).

As such, the acquisition frequency of the position information can be controlled according to the movement distance per unit time. Thereby, acquisition of the position information at a stable interval can be realized. In addition, the acquisition frequency at the time of a low-speed movement is decreased, so that power consumed to acquire the position information can be decreased.

In the embodiment of the present disclosure, the example of the case in which the acquisition frequency of the position information by the position information acquiring unit 110 is controlled on the basis of the movement distance per unit time has been described. However, other control may be performed. For example, the control unit 150 may determine whether the base station selection process is restricted on the basis of the movement distance per unit time, and may control the wireless communication unit 140 executing the base station selection process on the basis of a determination result. For example, when the movement distance per unit time is equal to or more than a threshold value, the control unit 150 determines that the wireless communication apparatus 100 moves at a high speed and restricts the base station selection process. Meanwhile, when the movement distance per unit time is less than the threshold value, the control unit 150 determines that the wireless communication apparatus 100 does not move and does not restrict the base station selection process.

### [Example of Control Content]

FIG. 2 is a diagram schematically illustrating control content of the control unit 150 according to the first embodiment of the present disclosure.

a of FIG. 2 illustrates control content according to a mobile network supported by a wireless communication apparatus. In a of FIG. 2, only four patterns of the WiFi and the UMTS, the WiFi and the EV-DO, the WiFi, the LTE, and the UMTS, and the WiFi, the LTE, and the EV-DO are illustrated for easiness of explanation. However, the embodiment of the present disclosure can be applied to the case of using other patterns.

Here, in “standard setting”, a communication system (network) to be preferentially used in the standard is illustrated. In addition, in a “process at the time of a high-speed movement”, control content of each of when the base station selection process is restricted and when the base station selection process is not restricted is illustrated. In addition, in “stop at a station”, a communication system to be preferentially used at the time of stop at the station (and at the time of stop at a bus stop) is illustrated. An example regarding the stop at the station is illustrated in a second embodiment of the present disclosure.

Each setting content can be changed by a user operation using a setting screen 190 illustrated in FIG. 3. A display example in the case in which each item surrounded by a rectangle 197 of a dotted line illustrated in a of FIG. 2 is set is illustrated in FIG. 3.

In addition, b of FIG. 2 illustrates the details of each content regarding the “standard setting” and the “stop at the station” illustrated in a of FIG. 2. A figure (figure in a white circle) of each item illustrates order of a sequence when a used communication system is set.

### [Display Example of Setting Screen]

FIG. 3 is a diagram illustrating an example (setting screen 190) of a setting screen that is displayed on the display unit 170 according to the first embodiment of the present disclosure.

The setting screen 190 is a display screen to set control content executed by the control unit 150. In an upper display region of the setting screen 190, for example, a battery icon display region 191, a time display region 192, and an antenna bar display region 193 are displayed. In a setting region of the setting screen 190, a standard network setting region 194, a switching restriction setting region 195 at the time of a high-speed movement, and a WiFi priority setting region 196 at the time of a station stop are displayed.

The standard network setting region 194 is a region to set a communication system (network) to be preferentially used in the standard.

The switching restriction setting region 195 at the time of the high-speed movement is a region to set whether or not to restrict the base station selection process at the time of the high-speed movement.

The WiFi priority setting region 196 at the time of the station stop is a region to set whether or not to preferentially use the WiFi at the time of the station stop.

The setting content that is determined by the user operation in the setting screen 190 is held by the control unit 150. The control unit 150 performs each control regarding the communication process, on the basis of the setting content.

### [Operation Example of Wireless Communication Apparatus]

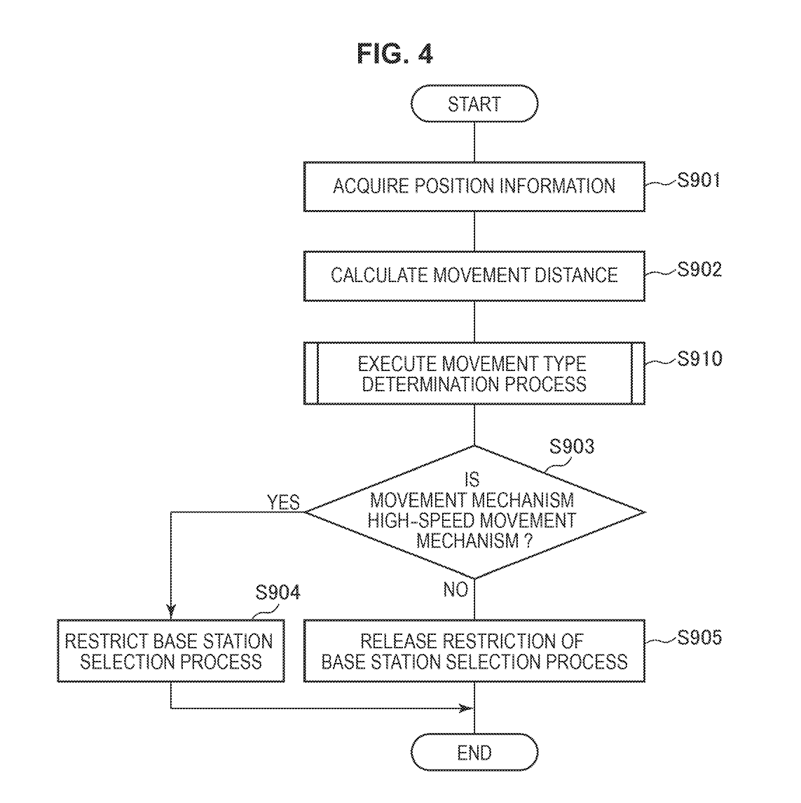

FIG. 4 is a flowchart illustrating an example of a process sequence of a base station selection process control process of the wireless communication apparatus 100 according to the first embodiment of the present disclosure.

First, the position information acquiring unit 110 acquires information (position information) to specify a position (current position) where the wireless communication apparatus 100 exists (step S901). Next, the movement distance calculating unit 120 calculates a movement distance of the wireless communication apparatus 100, on the basis of the position information acquired by the position information acquiring unit 110 (step S902).

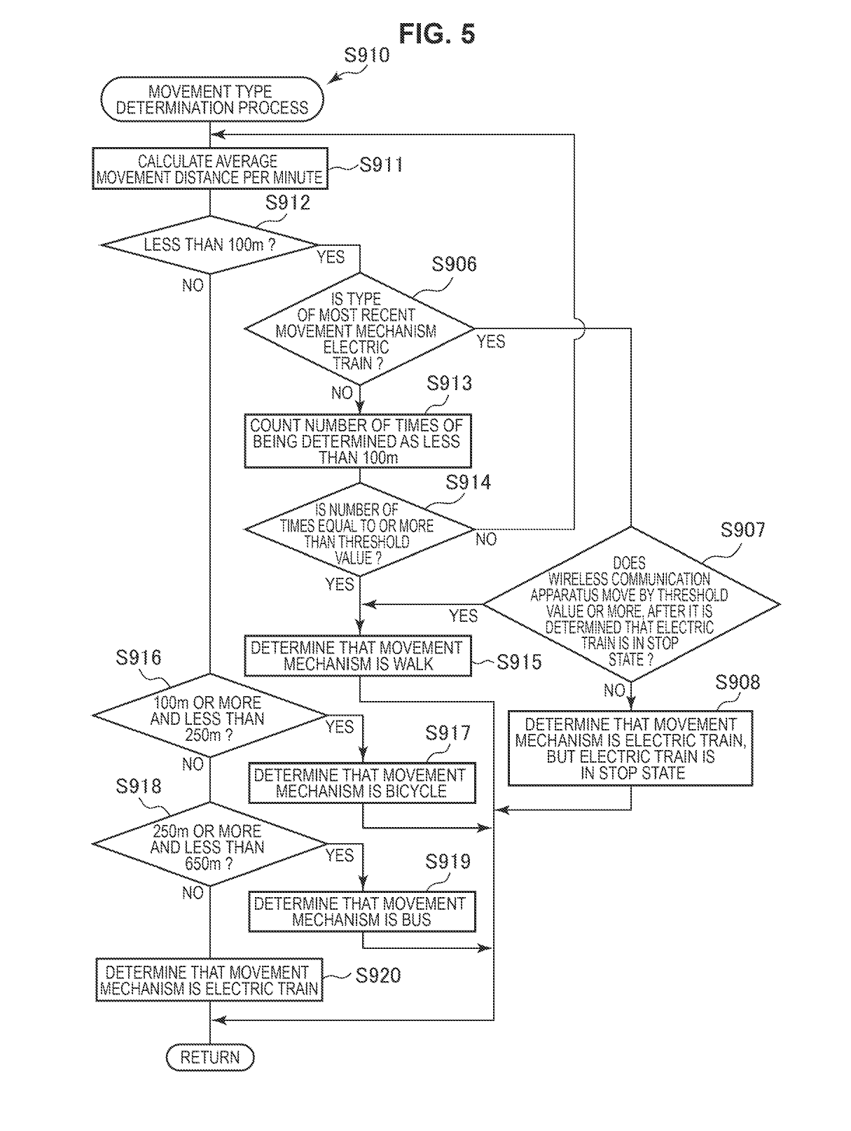

Next, the movement type determination process is executed (step S910). The movement type determination process will be described in detail with reference to FIG. 5.

Next, the control unit 150 determines whether a movement mechanism of the user is a high-speed movement mechanism (for example, a powered vehicle) (step S903). When the movement mechanism of the user is the high-speed movement mechanism (step S903), the control unit 150 restricts the base station selection process (step S904). That is, the control unit 150 puts restrictions to execute only the processes such as the handover, the cell selection, and the cell reselection between the same communication systems in which the service regions of the cell sizes are large.

Meanwhile, when the movement mechanism of the user is not the high-speed movement mechanism (step S903), the base station selection process is not restricted (step S905). That is, the restriction of the base station selection process is released. In this case, the restriction of the execution of the processes such as the handover, the cell selection, and the cell reselection between the different communication systems is released. Step S910 is an example of a determination sequence according to an embodiment of the present disclosure. In addition, steps S903 to S905 are an example of a control sequence according to an embodiment of the present disclosure.

In this example, it is determined whether or not to restrict the base station selection process, according to whether the movement mechanism of the user is the high-speed movement mechanism (for example, the powered vehicle). However, a type other than the high-speed movement mechanism may be used as the determination standard. In addition, it may be determined whether or not to restrict the base station selection process, using a plurality of types as the determination standard. For example, it may be determined whether or not to restrict the base station selection process, according to whether the movement mechanism of the user is a “bus”, an “automobile”, or a “train”. In addition, the case in which a state in which the movement mechanism of the user is a predetermined type is continued for a constant time may be set as a condition. For example, only when a state in which the movement mechanism of the user is the high-speed movement mechanism is continued for a constant time (for example, 10 minutes), the base station selection process may be restricted.

In addition, it may be determined whether or not to restrict the base station selection process, on the basis of the movement state (for example, a movement speed and a movement distance per unit time) of the wireless communication apparatus 100. For example, when the movement speed of the wireless communication apparatus 100 is large on the basis of a threshold value (for example, 30 km/h), the base station selection process is restricted and when the movement speed of the wireless communication apparatus 100 is small on the basis of the threshold value, the restriction of the base station selection process can be released.

FIG. 5 is a flowchart illustrating an example of a movement type determination process sequence (a process sequence of step S910 illustrated in FIG. 4) of the base station selection process control process of the wireless communication apparatus 100 according to the first embodiment of the present disclosure. In the process sequence, for example, the high-speed movement mechanism is an electric train. In the process sequence, for example, the determination number of times is counted when the average movement distance per minute is less than 100 m and the most recently determined type of the movement mechanism is not the electric train and the “walk” is determined on the basis of the count number. In addition, in the process sequence, for example, the type of the movement mechanism of the user is determined using the average value (average movement distance per minute) of the movement distances per minute.

First, the movement type determining unit 130 calculates the average value (average movement distance per minute) of the movement distances (movement distances per minute) calculated by the movement distance calculating unit 120 (step S911). For example, an average value of 3 minutes is calculated for the movement distances calculated at an interval of one minute.

Next, the movement type determining unit 130 determines whether the average movement distance per minute is less than 100 m (step S912). When the average movement distance per minute is less than 100 m (step S912), the movement type determining unit 130 determines whether the most recently determined type of the movement mechanism is the electric train (step S906). When the most recently determined type of the movement mechanism is not the electric train (step S906), the movement type determining unit 130 counts the number of times of being determined as “less than 100 m” (step S913). Next, the movement type determining unit 130 determines whether the count number is equal to or more than the threshold value (step S914). When the count number is less than the threshold value, the movement type determining unit 130 returns to step S911. Here, the threshold value may be set to 3 to 5, when the determination process on whether the average movement distance per minute is less than 100 m is executed at an interval of 3 minutes.

When the count number is equal to or more than the threshold value (step S914), the movement type determining unit 130 determines that the movement mechanism of the user is the “walk” (step S915).

When the most recently determined type of the movement mechanism is the electric train (step S906), the movement type determining unit 130 determines whether the wireless communication apparatus 100 moves by the threshold value or more, after it is determined that “the electric train is in a stop state” (step S907). When the wireless communication apparatus 100 moves by the threshold value or more (step S907), it is assumed that the user moves by the walk. For this reason, the movement type determining unit 130 determines that the movement mechanism of the user is the “walk” (step S915). Meanwhile, when the wireless communication apparatus 100 does not move by the threshold value or more (step S907), it is assumed that the electric train stops at the station. For this reason, the movement type determining unit 130 determines that the movement mechanism of the user is the “electric train”, but the electric train is in the “stop state” (step S908). Here, 100 to 300 (m) may be used as the threshold value used in step S907.

In addition, the movement type determining unit 130 determines whether the average movement distance per minute is equal to or more than 100 m and is less than 250 m (step S916). When the average movement distance per minute is equal to or more than 100 m and is less than 250 m (step S916), the movement type determining unit 130 determines that the movement mechanism of the user is the “bicycle” (step S917).

In addition, the movement type determining unit 130 determines whether the movement distance per minute is equal to or more than 250 m and is less than 650 m (step S918). When the movement distance per minute is equal to or more than 250 m and is less than 650 m, the movement type determining unit 130 determines that the movement mechanism of the user is the “bus” (step S919).

When the movement distance per minute is equal to or more than 650 m (step S918), the movement type determining unit 130 determines that the movement mechanism of the user is the “electric train” (step S920).

As such, in the first embodiment of the present disclosure, the movement mechanism (a railroad, a route bus, a taxi, an automobile, a bicycle, or a walk) of the user who has the wireless communication apparatus 100 can be specified. When it is determined that the movement mechanism is a specific movement mechanism (for example, a user is moving by a powered vehicle), the base station selection process of the wireless communication apparatus 100 is restricted. For example, it can be determined whether the base station selection process is restricted on the basis of a movement state (for example, a movement speed and a movement distance per unit time) of the wireless communication apparatus 100. Thereby, effective throughput and communication capacity can be improved. Because the frequent switching between the different communication systems can be prevented, consumption power can be effectively used.

### 2. Second Embodiment

In the first embodiment of the present disclosure, the example of the case in which the type of the movement mechanism is determined in the wireless communication apparatus and the base station selection process is restricted on the basis of the determination result has been described. However, the type of the movement mechanism of the wireless communication apparatus may be determined in an apparatus (for example, an information processing apparatus) other than the wireless communication apparatus and the base station selection process of the wireless communication apparatus may be restricted on the basis of a determination result.

Therefore, in a second embodiment of the present disclosure, an example of the case in which the type of the movement mechanism of the wireless communication apparatus is determined in the information processing apparatus and the base station selection process of the wireless communication apparatus is restricted on the basis of the determination result will be described.

### [Configuration Example of Communication System]

FIG. 6 is a block diagram illustrating a functional configuration example of a communication system 200 according to the second embodiment of the present disclosure.

The communication system 200 includes an information processing apparatus 210, a public network 220, a communication control apparatus 230, base stations 231 and 232, and wireless communication apparatuses 240 and 251 to 253.

The public network 220 is a public network such as a telephone network and the Internet. The public network 220 and the communication control apparatus 230 are connected through a gateway (not illustrated in the drawings).

The base stations 231 and 232 are base stations that are managed by the carrier. That is, the base stations 231 and 232 are moving object communication base stations (NodeB or eNodeB) that connect a wireless communication apparatus holding contract authentication information regarding the carrier and the communication control apparatus 230 managed by the carrier through a wireless line.

In FIG. 6, only one carrier (carrier managing the communication control apparatus 230 (for example, a carrier of the 3G system)) is illustrated for easiness of explanation. However, the present disclosure can be applied to the case in which two or more communication carriers exist. In FIG. 6, only the base stations 231 and 232 are illustrated as base stations managed by the carrier, for easiness of explanation. However, the present disclosure can be applied to the case in which the number of base stations managed by the carrier is one or three or more. When the carrier manages two or more base stations, the carrier may manage the base stations using different carrier frequencies and different communication methods.

The communication control apparatus 230 is a communication control apparatus managed by the carrier providing a wireless connection service and performs authentication control of the wireless communication apparatuses connected through the base stations 231 and 232. In addition, the communication control apparatus 230 connects the authenticated wireless communication apparatus to the public network 220 through the gateway (not illustrated in the drawings).

Here, the communication control apparatus 230 authenticates only the wireless communication apparatus holding the contract authentication information regarding the carrier managing the communication control apparatus 230, except for the specific case, among the wireless communication apparatuses connected through the base stations 231 and 232. The specific case is, for example, the case of calling by an urgent use (for example, the case of calling in the police or the fire department).

In addition, the communication control apparatus 230 outputs various information transmitted from the wireless communication apparatuses 240 and 251 to 253 through the base stations 231 and 232 to the information processing apparatus 210. The communication control apparatus 230 transmits the various information output from the information processing apparatus 210 to the wireless communication apparatuses 240 and 251 to 253 through the base stations 231 and 232.

### [Configuration Example of Information Processing Apparatus]

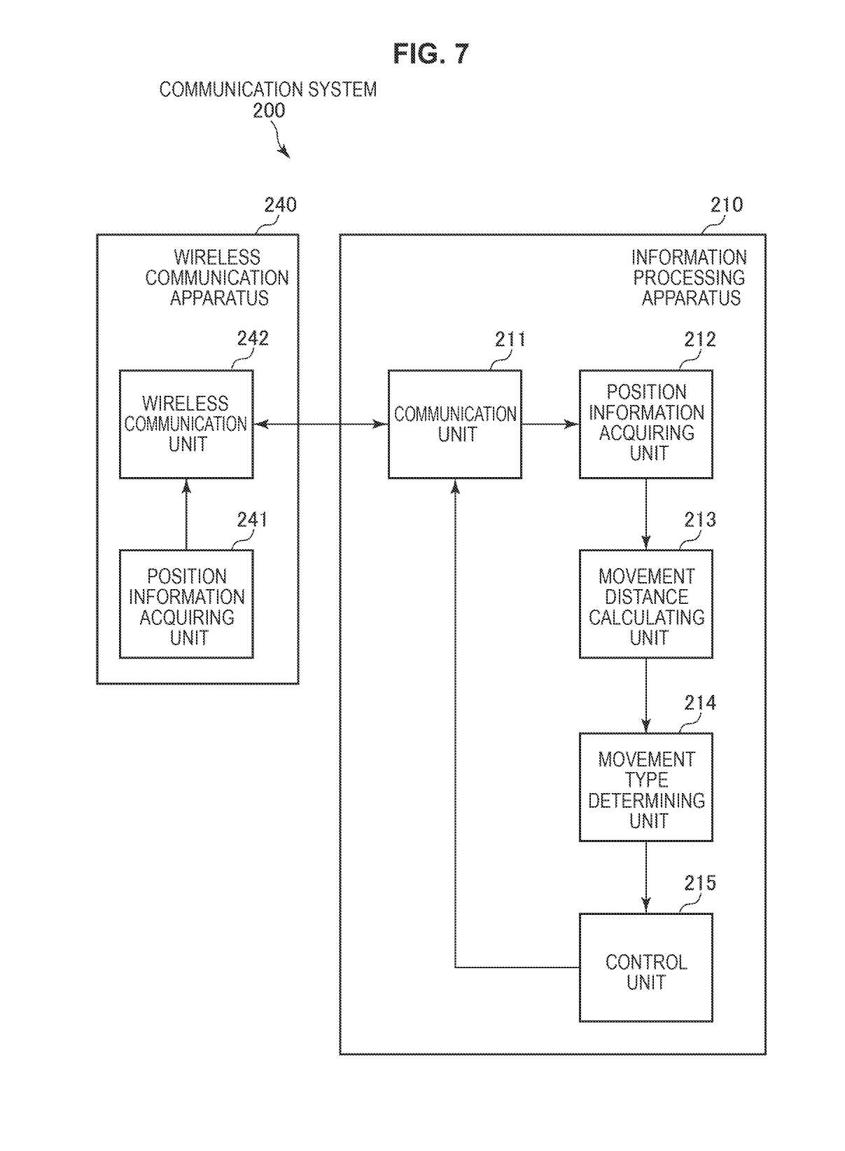

FIG. 7 is a block diagram illustrating functional configuration examples of the information processing apparatus 210 and the wireless communication apparatus 240 according to the second embodiment of the present disclosure. Because functional configurations of the wireless communication apparatuses (wireless communication apparatuses 251 to 253) other than the wireless communication apparatus 240 are the same as the functional configuration of the wireless communication apparatus 240, explanation thereof is omitted. In FIG. 7, illustration of the communication control apparatus 230 and the base stations 231 and 232 is omitted for easiness of explanation.

The wireless communication apparatus 240 includes a position information acquiring unit 241 and a wireless communication unit 242. The position information acquiring unit 241 and the wireless communication unit 242 correspond to the position information acquiring unit 110 and the wireless communication unit 140 illustrated in FIG. 1. For this reason, only a difference with the wireless communication apparatus 100 is mainly described and explanation of the other portion is omitted.

The position information acquiring unit 241 acquires position information with a fixed or variable period and outputs the acquired position information to the wireless communication unit 242.

The wireless communication unit 242 transmits the position information acquired by the position information acquiring unit 241 to the information processing apparatus 210 with a fixed or varied period. In the wireless communication unit 242, a base station selection process is restricted on the basis of control of the information processing apparatus 210.

The information processing apparatus 210 includes a communication unit 211, a position information acquiring unit 212, a movement distance calculating unit 213, a movement type determining unit 214, and a control unit 215. The position information acquiring unit 212, the movement distance calculating unit 213, the movement type determining unit 214, and the control unit 215 correspond to the individual units of the same names in the wireless communication apparatus 100 illustrated in FIG. 1. For this reason, with respect to the individual units common to the wireless communication apparatus 100, only a difference with the wireless communication apparatus 100 is mainly described and explanation of the other portion is omitted.

The communication unit 211 exchanges various information with the wireless communication apparatus 240, through the base stations 231 and 232 managed by the carrier (carrier managing the communication control apparatus 230).

The position information acquiring unit 212 acquires the position information included in the information transmitted from the wireless communication apparatus 240, through the communication unit 211. Here, when the position information is acquired from the plurality of wireless communication apparatuses, the position information acquiring unit 212 arranges the position information for each wireless communication apparatus in times series. In addition, when the position information is acquired from the plurality of wireless communication apparatuses, the movement distance calculating unit 213 and the movement type determining unit 214 perform calculation of the movement distance and determination of the type of the movement mechanism, for each wireless communication apparatus.

The control unit 215 performs control regarding the base station selection process of the wireless communication apparatus 240, on the basis of the type of the movement mechanism of the wireless communication apparatus 240 determined by the movement type determining unit 214. Specifically, the control unit 215 performs control to transmit a control signal to perform control regarding the base station selection process of the wireless communication apparatus 240 to the wireless communication apparatus 240 through the communication unit 211.

### [Communication Example]

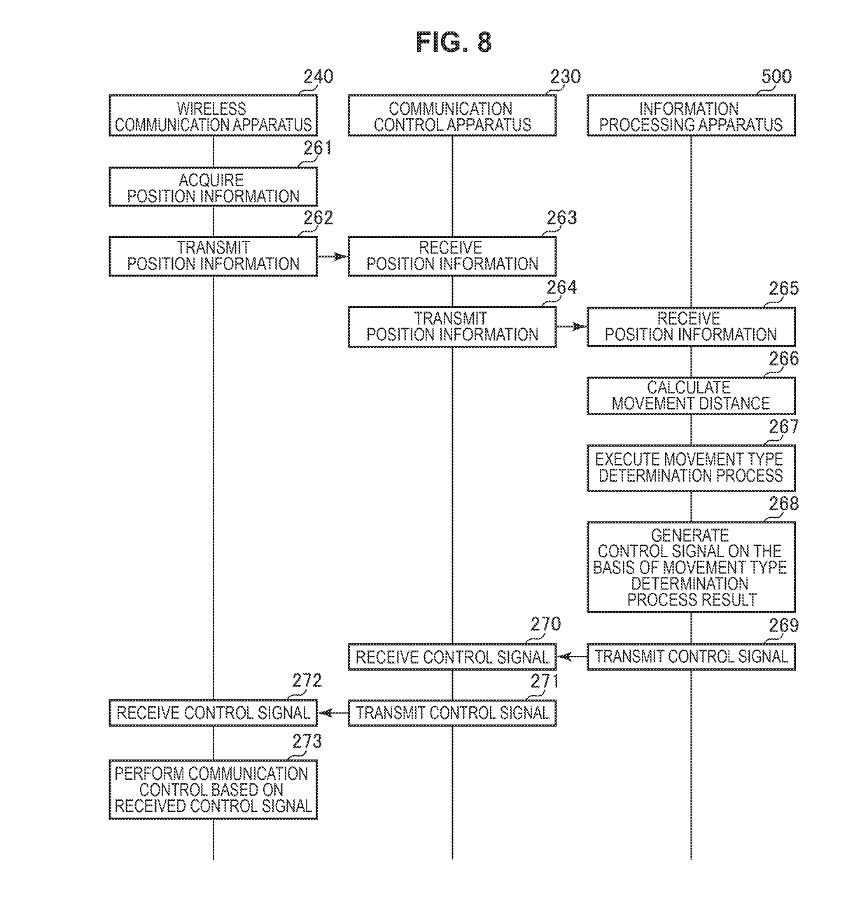

FIG. 8 is a sequence chart illustrating an example of a communication process between the individual apparatuses constituting the communication system 200 according to the second embodiment of the present disclosure. In FIG. 8, illustration of the base stations 231 and 232 illustrated in FIG. 6 is omitted for easiness of explanation.

First, the position information acquiring unit 241 in the wireless communication apparatus 240 acquires the position information (261). Next, the wireless communication unit 242 transmits the acquired position information to the information processing apparatus 210 through the communication control apparatus 230 (262 to 265). The transmission of the position information to the information processing apparatus 210 is performed with a fixed or variable period.

If the position information is received (265), the position information acquiring unit 212 of the information processing apparatus 210 acquires the position information and the movement distance calculating unit 213 of the information processing apparatus 210 calculates the movement distance of the wireless communication apparatus 240 on the basis of the position information (266). Next, the movement type determining unit 214 of the information processing apparatus 210 determines the type of the movement mechanism of the wireless communication apparatus 240 (267).

Next, the control unit 215 of the information processing apparatus 210 generates a control signal to perform control regarding the base station selection process of the wireless communication apparatus 240, on the basis of the determination result by the movement type determining unit 214 (268). Next, the control unit 215 of the information processing apparatus 210 transmits the generated control signal to the wireless communication apparatus 240 through the communication control apparatus 230 (269 to 272).

If the wireless communication unit 242 of the wireless communication apparatus 240 receives the control signal (272), the wireless communication unit 242 executes the wireless communication on the basis of the control signal (273). For example, when the control signal to restrict the base station selection process is received, the wireless communication unit 242 of the wireless communication apparatus 240 executes only the processes such as the handover, the cell selection, and the cell reselection between the same communication systems in which service regions of cell sizes are large. Meanwhile, when a control signal to release the control regarding the base station selection process is received, the wireless communication unit 242 of the wireless communication apparatus 240 releases the restriction and executes the processes such as the handover, the cell selection, and the cell reselection between the different communication systems.

As such, in the second embodiment of the present disclosure, the wireless communication apparatus 240 performs the acquisition of the position information and the transmission of the position information and the information processing apparatus 210 performs control regarding the base station selection process based on the type of the movement mechanism of the wireless communication apparatus. For this reason, load of each process in the wireless communication apparatus 240 can be greatly decreased and consumption power can be effectively used.

### 3. Third Embodiment

In the first and second embodiments of the present disclosure, the example of the case in which the type of the movement mechanism of the wireless communication apparatus is determined and the base station selection process is restricted on the basis of the determination result has been described. Here, the control regarding the base station selection process can be more appropriately performed by considering elements (for example, a movement path of the wireless communication apparatus) other than the type of the movement mechanism.

Therefore, in a third embodiment of the present disclosure, an example of the case in which determination of the type of the movement mechanism of the wireless communication apparatus and specification of the movement path of the wireless communication apparatus are performed and the base station selection process of the wireless communication apparatus is restricted on the basis of a result thereof will be described.

### [Configuration Example of Wireless Communication Apparatus]

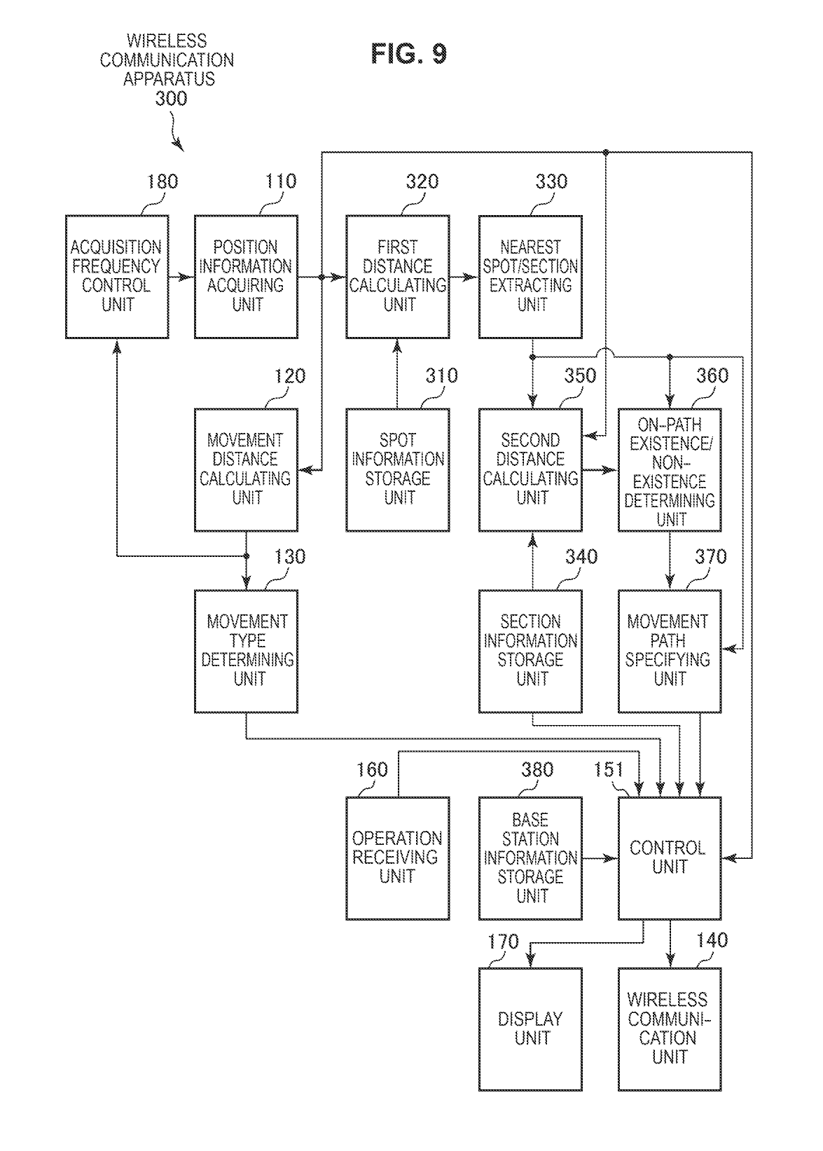

FIG. 9 is a block diagram illustrating a functional configuration example of a wireless communication apparatus 300 according to the third embodiment of the present disclosure. The wireless communication apparatus 300 is obtained by changing a part of the wireless communication apparatus 100 illustrated in FIG. 1. For this reason, portions common to the wireless communication apparatus 100 are denoted with the same reference numerals and explanation thereof is omitted.

The wireless communication apparatus 300 includes a position information acquiring unit 110, a movement distance calculating unit 120, a movement type determining unit 130, a wireless communication unit 140, a control unit 151, an operation receiving unit 160, a display unit 170, an acquisition frequency control unit 180, and a spot information storage unit 310. The wireless communication apparatus 300 further includes a first distance calculating unit 320, a nearest spot/section extracting unit 330, a section information storage unit 340, a second distance calculating unit 350, an on-path existence/non-existence determining unit 360, a movement path specifying unit 370, and a base station information storage unit 380.

The position information acquiring unit 110 outputs the acquired position information to the movement distance calculating unit 120, the control unit 151, the first distance calculating unit 320, and the second distance calculating unit 350.

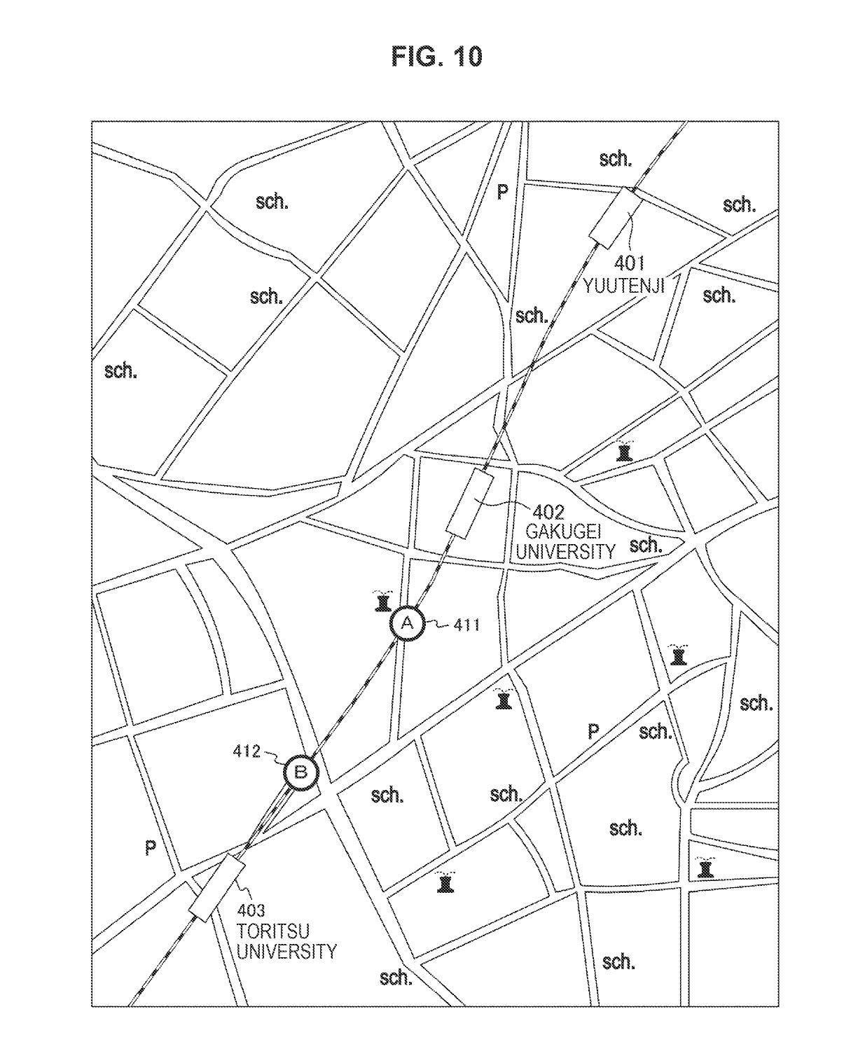

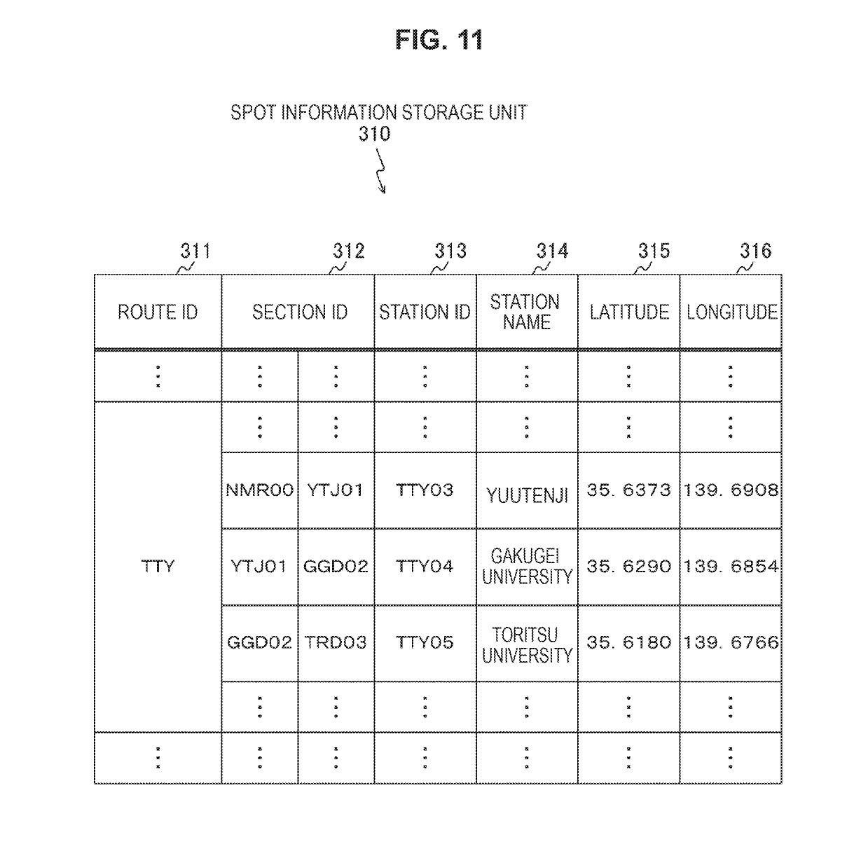

The spot information storage unit 310 stores information (spot information) to specify each spot (for example, a station) arranged on one or more paths (for example, a route of an electric train) to be previously set and supplies the stored spot information to the first distance calculating unit 320. The spot information that is stored in the spot information storage unit 310 will be described in detail with reference to FIGS. 10 and 11.

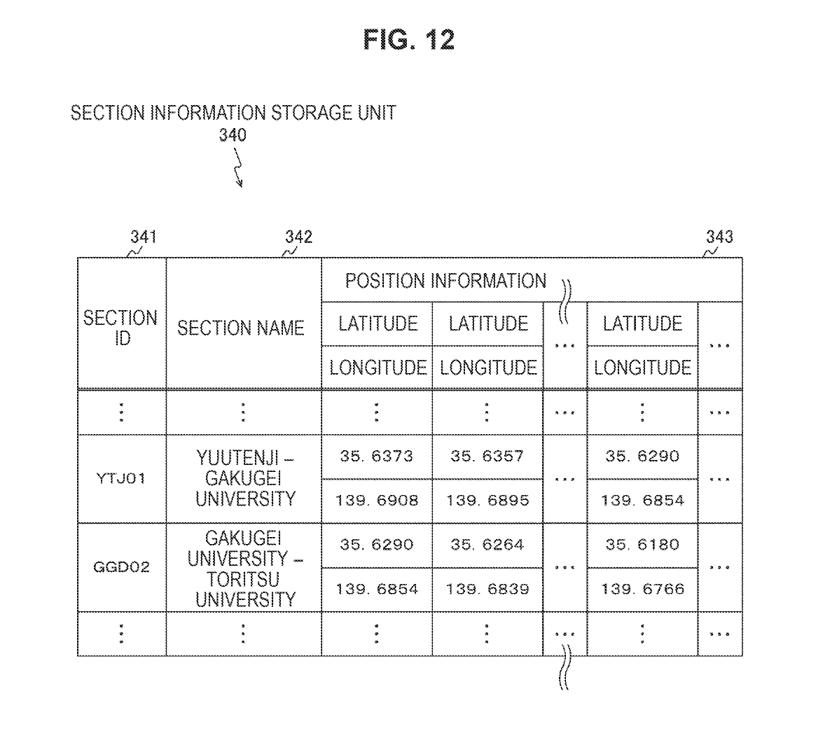

The section information storage unit 340 stores information (section information) in which a section of two adjacent spots on a path and position information to specify each position in the section are associated with each other. In addition, the section information storage unit 340 supplies the stored section information to the control unit 151 and the second distance calculating unit 350. The section information that is stored in the section information storage unit 340 will be described in detail with reference to FIGS. 10 and 12.

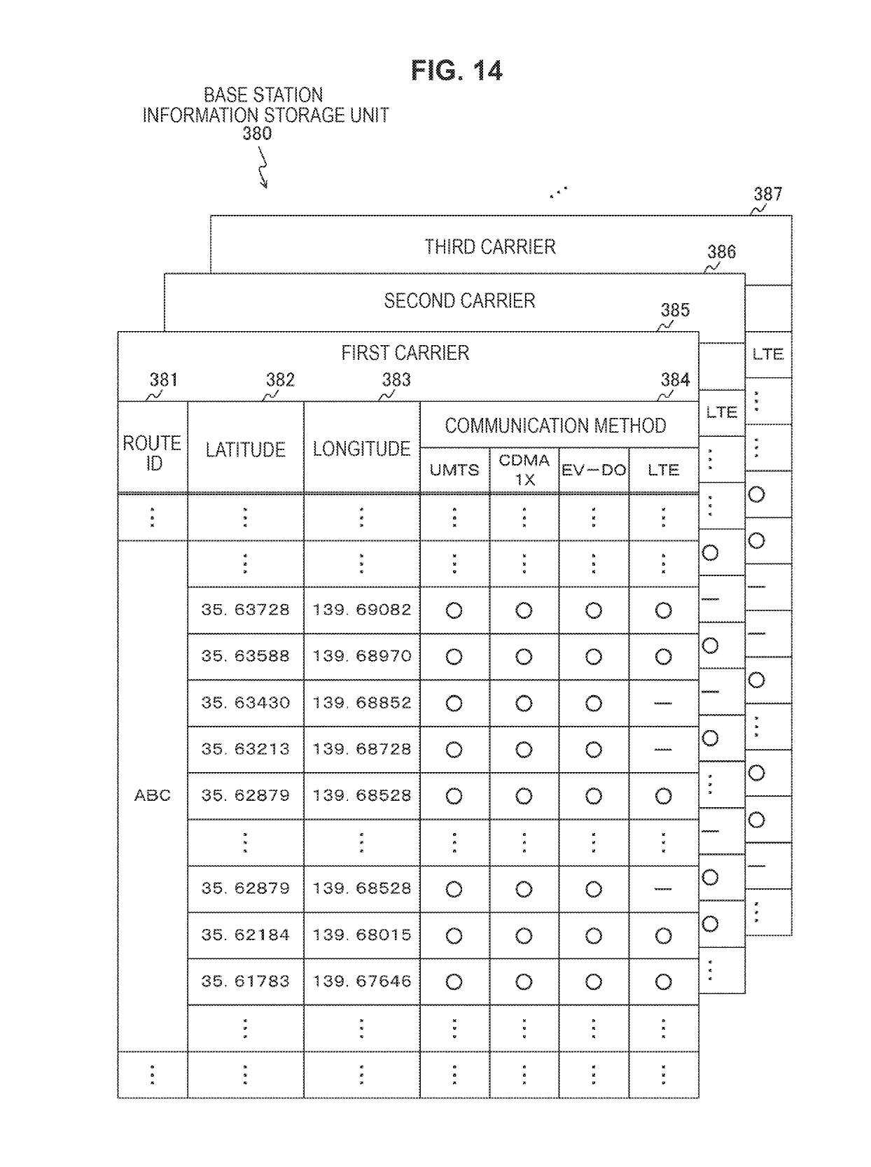

The base station information storage unit 380 stores information (base station information) regarding a communication system usable at a constant interval (or a variable interval) on a path, for each carrier, and supplies the stored base station information to the control unit 151. That is, information (base station information) regarding whether use of a communication system with respect to each position on a path specified by the movement path specifying unit 370 is enabled is stored in the base station information storage unit 380. The base station information that is stored in the base station information storage unit 380 will be described in detail with reference to FIGS. 10 and 14.

### [Example of Map]

FIG. 10 is a diagram illustrating a map including a part of each spot of which each information is stored in the spot information storage unit 310 according to the third embodiment of the present disclosure.

The map illustrated in FIG. 10 is a map that includes a part of Tokyu Toyoko Line. Specifically, the map illustrated in FIG. 10 is a map that includes each station (a Yuutenji station 401, a Gakugei University station 402, and a Toritsu University station 403) of Tokyu Toyoko Line and its surroundings. In FIG. 10, detailed portions are omitted. In addition, white circles (an A spot 411 and a B spot 412) will be described in detail with reference to FIG. 9.

### [Example of Storage Content of Spot Information Storage Unit]

FIG. 11 is a diagram schematically illustrating an example of storage content of the spot information storage unit 310 according to the third embodiment of the present disclosure.

In the spot information storage unit 310, a route ID 311, a section ID 312, a station ID 313, a station name 314, a latitude 315, and a longitude 316 are associated and stored.

The route ID 311 is identification information to identify a route. For example, “TTY” is stored as a route ID of Tokyu Toyoko Line in the route ID 311.

The section ID 312 is identification information to identify a section between two stations and one or more section IDs are stored for each station. For example, “YTJ01” is stored as a section ID between the Yuutenji station and the Gakugei University station of Tokyu Toyoko Line in the section ID 312.

The station ID 313 is identification information to identify a station. For example, “TTY03” is stored as a station ID of the Yuutenji station of Tokyu Toyoko Line in the station ID 313.

The station name 314 is a name of a station.

The latitude 315 is a latitude to specify a position where a station exists and the longitude 316 is a longitude to specify a position where a station exists.

In FIG. 11, only each information corresponding to the three stations (“Yuutenji”, “Gakugei University”, and “Toritsu University”) existing on the map illustrated in FIG. 10 is illustrated for easiness of explanation.

In the embodiment of the present disclosure, the example of the case in which the previously set path is set as the route of the electric train and the spots arranged on the path are set as the stations such as the Yuutenji station, the Gakugei University station, and the Toritsu University station is described. However, the path and the spots are not limited thereto and may be applied to any path and any spots. For example, the previously set path may be set as an expressway and the spots arranged on the path may be set as a bus stop, a tollgate, an interchange, a service area, and a parking area of the expressway. For example, the previously set path may be set as a road (for example, a highway and a bus route) and the spots arranged on the path may be set as an intersection, some or all of addresses (for example, O-O), a store, a building, a bus stop, a historic spot, a beauty spot, a park, a river, and a harbor. In addition, the spot arranged on the path may be set as at least one of the above examples. For example, the previously set path may be set as a river (for example, a route of a liner) and the spot arranged on the path may be set as a departure and arrival place of the liner.

### [Example of Storage Content of Section Information Storage Unit]

FIG. 12 is a diagram schematically illustrating an example of storage content of the section information storage unit 340 according to the third embodiment of the present disclosure.

In the section information storage unit 340, a section ID 341, a section name 342, and position information 343 are associated and stored.

The section ID 341 is identification information to identify a section between two stations. The section ID 341 corresponds to the section ID 312 illustrated in FIG. 11.

The section name 342 is a name that shows a section between stations.

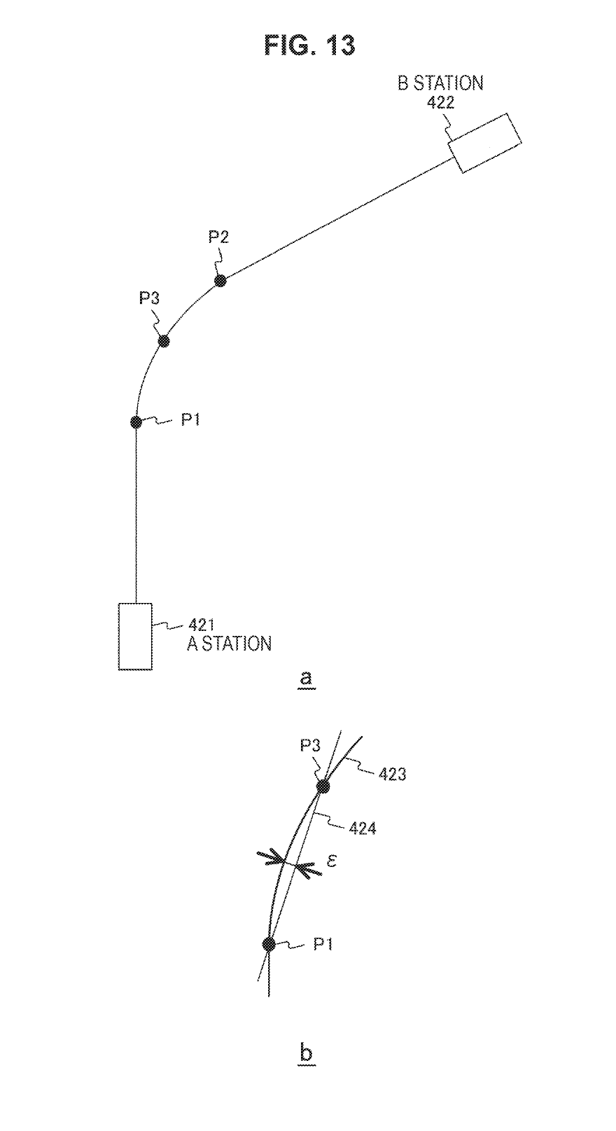

The position information 343 is information to identify a section between stations and one or more position information (latitude and longitude) to specify a position on a path between the stations are stored in the position information 343. A method of setting the position information stored in the position information 343 will be described in detail with reference to FIG. 13.

In FIG. 12, only each information corresponding to the three stations (“Yuutenji”, “Gakugei University”, and “Toritsu University”) existing on the map illustrated in FIG. 10 is illustrated for easiness of explanation.

As such, in the embodiment of the present disclosure, a region between two adjacent stations of the Yuutenji station and the Gakugei University station is set as one section and a region between two adjacent stations of the Gakugei University station and the Toritsu University station is set as the other section. In the section information storage unit 340, information (section information) regarding latitudes and longitudes of one or more positions included in each section is stored. That is, for all of the spots (for example, all stations of Tokyu Toyoko Line) included in one path (for example, Tokyu Toyoko Line), section information in which each region between adjacent spots is set as one section is stored in the section information storage unit 340.

### [Setting Example of Position Information]

FIG. 13 is a diagram schematically illustrating an example of a method of setting position information stored in the section information storage unit 340 according to the third embodiment of the present disclosure.

a of FIG. 13 illustrates a section between an A station 421 and a B station 422. b of FIG. 13 illustrates a part of a path between the A station 421 and the B station 422 and a primary approximate line.

As illustrated in a of FIG. 13, a section between the A station 421 and P1 and a section between P2 and the B station 422 are straight lines (or nearly straight lines). However, a section between the P1 and the P2 is a curved line.

Here, for the sections (the section between the A station 421 and the P1 and the section between the P2 and the B station 422) to be the straight lines, even though a plurality of position information do not exist in the sections, a primary approximation is enabled when the path is modeled. For this reason, for the sections to be the straight lines, only position information of ends (the A station 421 and the P1 and the P2 and the B station 422) of the sections can be set as storage targets of the section information storage unit 340.

Meanwhile, for the section (section between the P1 and the P2) to be the curved line, for example, when modeling is performed by a primary approximate expression, position information of a plurality of spots becomes necessary.

b of FIG. 13 illustrates a path 423 between the A station 421 and the B station 422 and a primary approximate line 424 of the P1 and the P3. In addition, a maximum value of an error of the path 423 between the A station 421 and the B station 422 and the primary approximate line 424 is set as E.

Here, arrangement positions of the position information between the P1 and the P3 can be set according to an allowable value of E. In general, if the curvature of the curved line increases, the number of points (the number of necessary position information) increases. For example, the case in which, when the error of the position information acquired by the position information acquiring unit 110 and the modeled path is less than 50 m, a determination process for determining that the wireless communication apparatus 300 exists on the path is executed is assumed. In this case, for example, 8 is modeled to become equal to or less than 25 m.

The method of setting the position information is not limited thereto and other setting may be performed. For example, the arrangement positions of the position information may be set at a constant interval (for example, an interval of 25 m) or may be set at a variable interval.

### [Example of Storage Content of Base Station Information Storage Unit]

FIG. 14 is a diagram schematically illustrating an example of storage content of the base station information storage unit 380 according to the third embodiment of the present disclosure.

In the base station information storage unit 380, a route ID 381, a latitude 382, a longitude 383, and a communication method 384 are associated and stored, for each carrier.

The route ID 381 is identification information to identify a route. The route ID 381 corresponds to the route ID 311 illustrated in FIG. 11.

The latitude 382 and the longitude 383 are position information to specify the position on the path corresponding to the route ID 381.

The communication method 384 is information (base station information) regarding a communication method (communication system) that can be used at the position corresponding to the position information stored in the latitude 382 and the longitude 383. That is, information (base station information) that shows whether the communication method of each position on the route is used is stored in the communication method 384. In FIG. 14, “O” is added to a usable communication method and “-” is added to an unusable communication method.

Here, each of the spot information in the spot information storage unit 310, the section information in the section information storage unit 340, and the base station information in the base station information storage unit 380 can be stored with one file format. Each information (the spot information, the section information, and the base station information) may be divided in a predetermined unit (for example, an area unit) and may be stored with a plurality of file formats.

In the spot information storage unit 310, spot information regarding all areas (for example, all over Japan) may be previously stored. Also, according to an area where the wireless communication apparatus 300 exists, spot information regarding the area or the area and the surrounding areas thereof may be downloaded from other information processing apparatus (for example, a spot information providing server), and the spot information may be stored in the spot information storage unit 310, whenever the spot information is downloaded. This can be applied to the section information in the section information storage unit 340 and the base station information in the base station information storage unit 380.

### [Configuration Example of Wireless Communication Apparatus]

The first distance calculating unit 320 illustrated in FIG. 9 calculates a distance (first distance) between a position (current position) where the wireless communication apparatus 300 exists and a station (spot). That is, the first distance calculating unit 320 calculates the first distance, on the basis of the position information acquired by the position information acquiring unit 110 and the spot information stored in the spot information storage unit 310. In addition, the first distance calculating unit 320 outputs information (first distance information) including the calculated first distance and information (spot information) stored in association with the station from which the first distance is calculated, to the nearest spot/section extracting unit 330. The spot information that become output targets are, for example, the route ID 311, the section ID 312, and the station ID 313 illustrated in FIG. 11.

For example, the first distance calculating unit 320 acquires spot information of a position specified by the position information acquired by the position information acquiring unit 110 and surrounding positions thereof from the spot information storage unit 310. In addition, the first distance calculating unit 320 calculates the distance (first distance) between the current position and the station, for each station, on the basis of the latitude 315 and the longitude 316 included in the acquired spot information and the latitude and the longitude included in the position information acquired by the position information acquiring unit 110.

For example, the A spot 411 on the map illustrated in FIG. 10 is set as the position where the wireless communication apparatus 300 exists. In this case, individual distances between the A spot 411 and the three stations (“Yuutenji”, “Gakugei University”, and “Toritsu University”) are calculated. In the example illustrated in FIG. 10, the distance of the A spot 411 and the Gakugei University station 402 becomes the shortest distance and the distance of the A spot 411 and the Yuutenji station 401 becomes the longest distance.

The nearest spot/section extracting unit 330 extracts the nearest spot of the wireless communication apparatus 300 and the path and the section where the wireless communication apparatus 300 exists, on the basis of the first distance information output from the first distance calculating unit 320. In addition, the nearest spot/section extracting unit 330 outputs an extraction result (including the route ID 311, the section ID 312, and the station ID 313 illustrated in FIG. 11) to the second distance calculating unit 350, the on-path existence/non-existence determining unit 360, and the movement path specifying unit 370.

For example, the nearest spot/section extracting unit 330 extracts the station in which the first distance calculated by the first distance calculating unit 320 is minimized, from the individual stations corresponding to the first distance information output from the first distance calculating unit 320, and selects the extracted station as the nearest spot. In this case, the nearest spot may be selected only when the first distance becomes less than a threshold value (for example, 500 m). That is, the station in which the first distance calculated by the first distance calculating unit 320 is less than the threshold value and the first distance is minimized is extracted from the individual stations stored in the spot information storage unit 310 and the extracted station is selected as the nearest spot. In the example illustrated in FIG. 10, the nearest spot of the A spot 411 becomes the Gakugei University station 402.

For example, the nearest spot/section extracting unit 330 extracts one or more sections associated with the selected nearest spot as the section where the wireless communication apparatus 300 exists. In addition, the nearest spot/section extracting unit 330 extracts the path associated with the extracted section as the path where the wireless communication apparatus 300 exists.

For example, when the number of sections corresponding to the extracted nearest spot is one (for example, when the nearest spot is a terminal station), the nearest spot/section extracting unit 330 extracts one section as the section where the wireless communication apparatus 300 exists. For example, when the number of sections corresponding to the determined nearest spot is two or more (for example, when the nearest spot is a non-stop station), the nearest spot/section extracting unit 330 extracts the two or more sections as the sections where the wireless communication apparatus 300 exists.

For example, the A spot 411 on the map illustrated in FIG. 10 is set as the position where the wireless communication apparatus 300 exists and the nearest spot is set as the Gakugei University station 402. In this case, the two sections (“Yuutenji-Gakugei University” and “Gakugei University-Toritsu University”) become the sections where the wireless communication apparatus 300 exists.

The second distance calculating unit 350 calculates a distance (second distance) of the position (position where the wireless communication apparatus 300 exists) specified by the position information acquired by the position information acquiring unit 110 and the section extracted by the nearest spot/section extracting unit 330. In addition, the second distance calculating unit 350 outputs information (second distance information) including the calculated second distance and information (spot information) stored in association with the section from which the second distance is calculated to the on-path existence/non-existence determining unit 360. The spot information that become output targets are, for example, the route ID 311, the section ID 312, and the station ID 313 illustrated in FIG. 11.

For example, the second distance calculating unit 350 acquires the position information 343 (illustrated in FIG. 12) associated with one or more sections corresponding to the extraction result (section ID 312 illustrated in FIG. 11) output from the nearest spot/section extracting unit 330, from the section information storage unit 340. Next, the second distance calculating unit 350 calculates the distance (second distance) of the wireless communication apparatus 300 and each section, on the basis of the acquired position information 343 (illustrated in FIG. 12) and the position information acquired by the position information acquiring unit 110. For example, a distance of a section (for example, a straight line corresponding to a primary approximate expression) specified by the two adjacent positions among the position information 343 associated with the section ID 341 “YTJ01” illustrated in FIG. 12 and the position where the wireless communication apparatus 300 exists is sequentially calculated. Here, the two adjacent position information among the position information 343 associated with the section ID 341 “YTJ01” illustrated in FIG. 12 are, for example, “latitude: 35. 6373 and longitude: 139. 6908” and “latitude: 35. 6357 and longitude: 139. 6895”. Likewise, a distance of a section specified by the two adjacent positions among the position information 343 associated with the section ID 341 “GGD02” illustrated in FIG. 12 and the position where the wireless communication apparatus 300 exists is sequentially calculated.

Furthermore, the second distance may be calculated by other calculation method. For example, an approximate expression of plural degrees is generated on the basis of the two position information (for example, two position information associated with the section ID 341 “YTJ01” illustrated in FIG. 12) associated with the section including the extracted nearest spot. In addition, a distance (second distance) of the position information (for example, a straight line corresponding to the approximate expression) obtained from the generated approximate expression and the position where the wireless communication apparatus 300 exists may be calculated.

The on-path existence/non-existence determining unit 360 determines whether the wireless communication apparatus 300 exists on a path including the nearest spot extracted by the nearest spot/section extracting unit 330, on the basis of the second distance calculated by the second distance calculating unit 350. In addition, the on-path existence/non-existence determining unit 360 outputs a determination result and the spot information (including the route ID 311, the section ID 312, and the station ID 313 illustrated in FIG. 11) to the movement path specifying unit 370.

For example, the on-path existence/non-existence determining unit 360 determines that the wireless communication apparatus 300 exists on the path including the nearest spot, when the minimized second distance among the second distances calculated by the second distance calculating unit 350 is small on the basis of the threshold value (for example, when the second distance is equal or less than the threshold value or is less than the threshold value). Here, the threshold value can be set as, for example, 50 m. A different value may be used as the threshold value and the threshold value may be changed by the user setting. For example, when precision of the on-path existence/non-existence determination process is increased, a small value (for example, 20 m to 40 m) can be set as the threshold value and when the precision of the on-path existence/non-existence determination process is decreased, a large value (for example, 60 m to 100 m) can be set as the threshold value.

As such, one path can be specified for the plurality of paths stored in the wireless communication apparatus 300 and it can be determined whether the wireless communication apparatus 300 moves on the path.

The movement path specifying unit 370 specifies a direction (movement direction) where the wireless communication apparatus 300 moves, in a path determined by the on-path existence/non-existence determining unit 360 as the path where the wireless communication apparatus 300 exists, and specifies a movement path of the wireless communication apparatus 300. In addition, the movement path specifying unit 370 outputs movement path information including the information (including the route ID 311, the section ID 312, and the station ID 313 illustrated in FIG. 11) regarding the path and the specified movement direction and movement path to the control unit 151. Here, the movement path is a path predicted as a path on which the wireless communication apparatus 300 moves and is specified from previously set one or more paths.

Here, an example of a method of specifying the movement direction will be described.

In the example illustrated in FIG. 10, the case in which the wireless communication apparatus 300 moves from the A spot 411 to the B spot 412 is assumed. In this case, when the wireless communication apparatus 300 exists at the A spot 411, the nearest spot/section extracting unit 330 extracts the Gakugei University station 402 as the nearest spot of the wireless communication apparatus 300. In addition, the movement path specifying unit 370 holds an extraction result (nearest spot “Gakugei University station”). Next, when the wireless communication apparatus 300 moves to the B spot 412, the nearest spot/section extracting unit 330 extracts the Toritsu University station 403 as the nearest spot of the wireless communication apparatus 300. In addition, the movement path specifying unit 370 holds an extraction result (nearest spot “Toritsu University”). As such, the nearest spot/section extracting unit 330 extracts a plurality of different nearest spots, on the basis of a plurality of position information acquired at different times and the position information included in the spot information, among the position information acquired by the position information acquiring unit 110. In addition, the nearest spot/section extracting unit 330 extracts two sections of “Gakugei University-Toritsu University” and “Toritsu University-Jiyugaoka (not illustrated in the drawings)” as sections including the nearest spot “Toritsu University”.

The movement path specifying unit 370 specifies a section “Gakugei University-Toritsu University” including the held two nearest spots (a most recent nearest spot “Gakugei University” and a current nearest spot “Toritsu University”), from the sections extracted by the nearest spot/section extracting unit 330. In addition, the movement path specifying unit 370 specifies a movement direction in the section “Gakugei University-Toritsu University”, on the basis of order of the held two nearest spots. For example, when the order of the held two nearest spots is Gakugei University→Toritsu University (that is, when the most recent nearest spot is “Gakugei University” and the current nearest spot is “Toritsu University”), “Gakugei University→Toritsu University” is specified as the movement direction. Meanwhile, when the order of the held two nearest spots is Toritsu University→Gakugei University (that is, when the most recent nearest spot is “Toritsu University” and the current nearest spot is “Gakugei University”), “Toritsu University→Gakugei University” is specified as the movement direction.

In the example illustrated in FIG. 10, because the wireless communication apparatus 300 moves from the A spot 411 to the B spot 412, “Gakugei University→Toritsu University” is specified as the movement direction.

As such, the movement path specifying unit 370 specifies a path advancing in the movement direction of the wireless communication apparatus 300 from the position where the wireless communication apparatus 300 exists, among the paths extracted on the basis of the position where the wireless communication apparatus 300 exists from the plurality of paths, as a movement path. Specifically, the movement path specifying unit 370 specifies the movement direction of the wireless communication apparatus 300 on the path determined as the path where the wireless communication apparatus 300 exists, on the basis of the plurality of different nearest spots. In addition, the movement path specifying unit 370 specifies a path advancing in the specified movement direction from the position where the wireless communication apparatus 300 exists, among the paths determined as the paths where the wireless communication apparatus 300 exists, as the movement path. As such, the movement path specifying unit 370 specifies a path including the extracted nearest spot as the movement path. In addition, the movement path specifying unit 370 specifies a path determined as the path where the wireless communication apparatus 300 exists as the movement path. That is, the movement path specifying unit 370 specifies the movement path of the wireless communication apparatus 300, on the basis of the position where the wireless communication apparatus 300 exists. The movement path specifying unit 370 is an example of a specifying unit according to an embodiment of the present disclosure.

Furthermore, the case in which the same station is continuously determined as the nearest spot of the wireless communication apparatus 300, when the distance between the stations is long or the speed of the electric train is slow, is assumed. For this reason, the movement path specifying unit 370 holds the specified movement direction and when the same station on the same route is continuously determined as the nearest spot, the movement path specifying unit 370 may use the most recently held movement direction.

The control unit 151 controls the base station selection process in the wireless communication unit 140, on the basis of the determination result by the movement type determining unit 130 and the specification result by the movement path specifying unit 370. Because the control unit 151 corresponds to the control unit 150 illustrated in FIG. 1, a difference with the control unit 150 will be mainly described.

For example, the control unit 151 performs control to restrict the base station selection process, when the type of the movement mechanism determined by the movement type determining unit 130 is a high-speed movement mechanism. However, even though the type of the movement mechanism determined by the movement type determining unit 130 is the high-speed movement mechanism, when the high-speed movement mechanism is in a stop state, the control unit 151 may not perform the restriction of the base station selection process. Even though the type of the movement mechanism is the high-speed movement mechanism and the high-speed movement mechanism is in a stop state, when a connection state of a specific communication service at the position where the high-speed movement mechanism exists satisfies a predetermined condition, the control unit 151 may restrict the base station selection process. For example, when the connection state of the specific communication service (for example, the WiFi) at the position where the high-speed movement mechanism (for example, the electric train) exists satisfies the predetermined condition (for example, when the number of connections is equal to or more than a threshold value), the base station selection process is restricted.

For example, the control unit 151 may restrict the base station selection process, only when the determined type of the movement mechanism is the high-speed movement mechanism and the number of times of switching between different communication methods on the specified movement path is large on the basis of a predetermined value.

For example, the case in which the wireless communication apparatus 300 moves along a section (35. 63728, 139. 69082-35. 61783, 139. 67646) in a path (path of a route ID381 “ABC” illustrated in FIG. 14) specified by the movement path specifying unit 370 is assumed. In this case, if LTE priority setting is given in the wireless communication apparatus 300, switching of the communication system to LTE→UMTS→LTE→UMTS→LTE is performed frequently.

For this reason, when a target moving along the section (section in the route ID381 “ABC” illustrated in FIG. 14) is determined by the movement path specifying unit 370, the control unit 151 restricts switching to the LTE. That is, the control unit 151 performs control to restrict the processes to the handover, the cell selection, and the cell reselection in the UMTS, without performing switching to the LTE.

As such, the control unit 151 determines whether the number of times of switching between systems in a section of a constant distance becomes equal to or more than a threshold value. In addition, the control unit 151 may perform control to restrict the processes to the handover, the cell selection, and the cell reselection between the same communication systems, only when the number of times of switching becomes equal to or more than the threshold value. Here, the same communication systems that restrict the handover, the cell selection, and the cell reselection are preferably systems (for example, the UMTS and the EV-DO) having the wide coverage.

For example, even though the type of the determined movement mechanism is the high-speed movement mechanism, when a specific communication service (for example, the WiFi) is provided in the high-speed movement mechanism (for example, the Shinkansen), the control unit 151 may make the restriction of the base station selection process not performed.

The control unit 151 may restrict the base station selection process, under a condition in which the determination result by the movement type determining unit 130 and the result by the movement path specifying unit 370 become equal to each other. For example, the control unit 151 may restrict the base station selection process, only when the movement type determining unit 130 determines the type of the movement mechanism as the “electric train” and the movement path specifying unit 370 specifies a path of the electric train. As such, precision of the path specification (or the type determination of the movement mechanism) can be improved by using the type of the movement mechanism and the specification of the movement path.

In addition, the case in which it becomes difficult to distinguish the movement of the vehicle on an expressway and the movement in the electric train in specifying the movement path, when routes of the expressway and a railroad run side by side, is assumed. In this case, the movement in the electric train or the vehicle can be determined using information regarding whether the electric train stops at a stop or whether the vehicle stops in a service area or a parking area on the expressway. For example, it can be determined whether the electric train stops at the stop, on the basis of a comparison result of a position when it is determined that the high-speed movement mechanism is in a stop station and a position (for example, a position of the station) at each spot stored in the stop information storage unit 310. Likewise, it can be determined whether the vehicle stops in the service area or the parking area on the expressway. As such, determination precision can be further improved by determining the routes of the expressway and the railroad.

Here, the movement path of the wireless communication apparatus 300 is specified on the basis of the current position of the wireless communication apparatus 300 and the movement direction specified by the movement path specifying unit 370. For example, the case in which the current position of the wireless communication apparatus 300 is the B spot 412 and the movement direction specified by the movement path specifying unit 370 is “Gakugei University→Toritsu University” is assumed. In this case, the movement path of the wireless communication apparatus 300 is a path in a predetermined range (for example, a range of 2000 m) from the B spot 412 on Tokyu Toyoko Line to a direction of Yokohama (a direction of the Toritsu University station 403).

The movement type determining unit 130 may acquire the movement path of the wireless communication apparatus 100 specified by the movement path specifying unit 370 and determine the type of the movement mechanism of the user using the movement path. For example, when the current position of the wireless communication apparatus 100 exists at each spot (for example, the station) on the movement path, it is assumed that the electric train stops at the station. For this reason, the movement type determining unit 130 may stop the determination process of the type of the movement mechanism of the user.

In addition, the movement type determining unit 130 may determine the type of the movement mechanism of the user by referring to the acquired movement path. For example, the movement type determining unit 130 may determine that the type of the movement mechanism of the user is the “electric train”, only when the acquired movement path is the route of the electric train and the movement distance per minute is equal to or more than 650 m. For example, the movement type determining unit 130 may determine that the type of the movement mechanism of the user is the “bus”, only when the acquired movement path is the bus route and the movement distance per minute is equal to or more than 250 m and is less than 650 m.

### [Operation Example of Wireless Communication Apparatus]

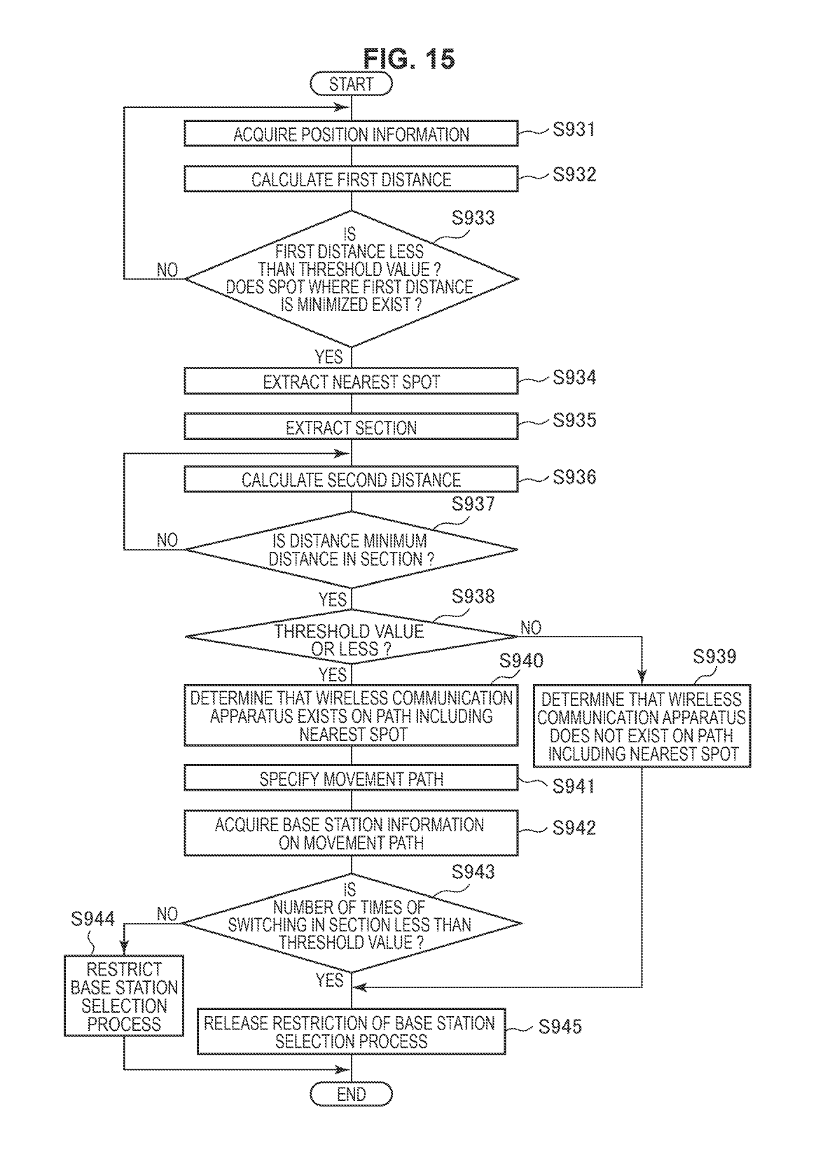

FIG. 15 is a flowchart illustrating an example of a process sequence of a base station selection process control process of the wireless communication apparatus 300 according to the third embodiment of the present disclosure.

First, the position information acquiring unit 110 acquires information (position information) to specify a position (current position) where the wireless communication apparatus 300 exists (step S931). Next, the first distance calculating unit 320 calculates a distance (first distance) between the current position and each spot (station), on the basis of the position information acquired by the position information acquiring unit 110 and the spot information stored in the spot information storage unit 310 (step S932).

Next, the nearest spot/section extracting unit 330 determines whether the first distance calculated by the first distance calculating unit 320 is less than the threshold value and determines whether the spot (station) where the first distance is minimized exists (step S933). Here, the threshold value may be set as, for example, 500 m. When the first distance is less than the threshold value and the spot (station) where the first distance is minimized does not exist, the nearest spot/section extracting unit 330 returns to step S931. Meanwhile, when the first distance is less than the threshold value and the spot (station) where the first distance is minimized exists (step S933), the nearest spot/section extracting unit 330 extracts the spot (station) as the nearest spot (step S934). In addition, the nearest spot/section extracting unit 330 extracts a section including the nearest spot (step S935).

Next, the second distance calculating unit 350 calculates a distance (second distance) of the current position and the section extracted by the nearest spot/section extracting unit 330 (step S936). Next, the on-path existence/non-existence determining unit 360 determines whether the wireless communication apparatus 300 exists on a path including the nearest spot extracted by the nearest spot/section extracting unit 330, on the basis of the second distance calculated by the second distance calculating unit 350 (steps S937 to S940). That is, the minimized second distance is selected from the second distances calculated for the extracted section (step S937). Next, it is determined whether the selected second distance is small on the basis of the threshold value (step S938). For example, it is determined whether the selected second distance is equal to or less than the threshold value (step S938).

When the selected second distance is more than the threshold value (step S938), the on-path existence/non-existence determining unit 360 determines that the wireless communication apparatus 300 does not exist on the path including the nearest spot (step S939) and ends the operation of the on-path communication quality display process. Meanwhile, when the selected second distance is equal to or less than the threshold value (step S938), the on-path existence/non-existence determining unit 360 determines that the wireless communication apparatus 300 exists on the path including the nearest spot (step S940).

Next, the movement path specifying unit 370 specifies the direction (movement direction) where the wireless communication apparatus 300 moves, on the path determined by the on-path existence/non-existence determining unit 360 as the path where the wireless communication apparatus 300 exists, and specifies the movement path of the wireless communication apparatus 300 (step S941).

Next, the control unit 151 acquires the base station information in the specified movement path of the wireless communication apparatus 300 from the base station information storage unit 380 (step S942). Next, the control unit 151 determines whether the number of times of switching in the section corresponding to the specified movement path of the wireless communication apparatus 300 is less than the threshold value, on the basis of the acquired base station information (step S943). The number of times of switching is the number of times of switching of the different communication method (for example, the number of times of switching between the UMTS and the LTE) in the communication method 384 illustrated in FIG. 14. In the example illustrated in FIG. 14, at least three “-” are included in the communication method 384 “LTE” of the first carrier 385. For this reason, the number of times of switching between the UMTS and the LTE becomes at least two times.

When the number of times of switching in the section corresponding to the movement path is equal to or more than the threshold value (step S943), the control unit 151 restricts the base station selection process (step S944). That is, the control unit 151 puts restrictions to execute only the processes such as the handover, the cell selection, and the cell reselection between the same communication systems in which the service regions of the cell sizes are large.

Meanwhile, when the number of times of switching in the section corresponding to the movement path is less than the threshold value (step S943), the control unit 151 does not restrict the base station selection process (step S945). That is, the restriction of the base station selection process is released. In this case, the restriction of the execution of the processes such as the handover, the cell selection, and the cell reselection between the different communication systems is released.

[Example of Case in which Spot Information is Managed in Area Unit]

Here, the spot information can be managed in an area unit. Therefore, an example of the case in which the spot information is managed in an area unit will be described hereinafter.

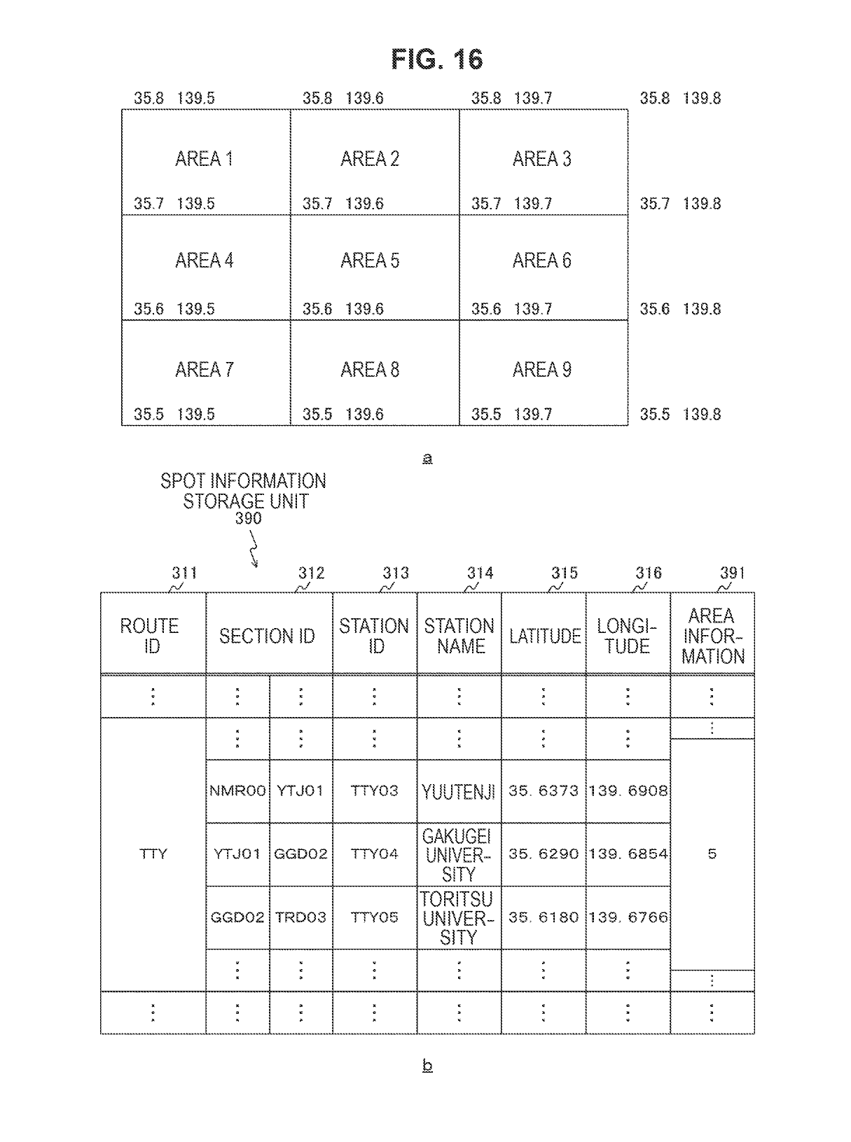

FIG. 16 is a diagram illustrating an example of each area in the case in which spot information stored in a spot information storage unit 390 according to the third embodiment of the present disclosure is managed in an area unit.

a of FIG. 16 illustrates an example of each area and b of FIG. 16 illustrates an example of storage content of the spot information storage unit 390. The spot information storage unit 390 is obtained by changing a part of the spot information storage unit 310 illustrated in FIG. 11. For this reason, portions common to the spot information storage unit 310 are denoted with the same reference numerals and explanation thereof is omitted.

As illustrated in a of FIG. 16, the spot information is managed in the area unit divided into a predetermined range of a rectangular shape. The corresponding latitudes and longitudes are added to four corners of a rectangular shape showing each area and are illustrated.

In the spot information storage unit 390 illustrated in b of FIG. 16, area information 391 is stored. The area information 391 is information corresponding to areas 1 to 9 illustrated in a of FIG. 16 and numbers of areas in which the individual spots (stations) are included are stored in the area information 391.

For example, the case in which position information (latitude: 35.63608 and longitude: 139.68985) is acquired by the position information acquiring unit 110 is assumed. In this case, the first distance calculating unit 320 calculates the first distance using only the spot information associated with the area 5. That is, only the spot information associated with the “area 5” in which the position information (latitude: 35.63608 and longitude: 139.68985) acquired by the position information acquiring unit 110 is included is used in calculating the first distance to extract the nearest spot (nearest station). As such, the spot information is managed for each area, so that, when the nearest spot is extracted, it is not necessary to calculate the first distances regarding the position information of the spots (stations) of all of the areas and the first distance regarding to the position information of the spot (station) included in the corresponding area may be calculated. Thereby, load of the process for extracting the nearest spot can be greatly alleviated and consumption power can be effectively used.

[Control Example of WiFi when User Gets on Electric Train (or when User Waits for Electric Train at Station)

Here, because the coverage of the WiFi is very narrow, it is difficult to receive a stable service during the movement by the electric train. For this reason, if the user desires to receive a wireless communication service in the WiFi during the movement by the electric train, radio resources may be wasted and power of a battery to drive the wireless communication apparatus 300 may also be wasted. Therefore, while the wireless communication apparatus 300 moves by the electric train, the WiFi is turned off, so that wasted consumption power can be decreased. Likewise, when the wireless communication apparatus 300 moves by other high-speed movement mechanism, the WiFi is turned off, so that wasted consumption power can be decreased.

For example, the case in which the user holding the wireless communication apparatus 300 gets on the electric train is assumed. In this case, it is determined by the movement type determining unit 130 that the wireless communication apparatus 300 moves by the electric train. As such, when it is determined that the wireless communication apparatus 300 moves by the electric train, as described above, the control unit 151 performs control not to turn on the WiFi, while it is determined by the movement distance calculating unit 120 that the wireless communication apparatus 300 moves. That is, the WiFi is restricted.

Recently, for the purpose of traffic off-load, the WiFi is often installed at the station. For this reason, the user can receive a high-speed service using the WiFi, while the electric train stops at the station (or while the user waits for the electric train at the station). Therefore, when it is determined by the movement type determining unit 130 that the electric train stops at the station (or the user waits for the electric train at the station), the control unit 151 may release the restriction of the WiFi and perform control to receive the service of the WiFi. In this case, the control unit 151 may determine whether the service of the WiFi can be received at the stop, on the basis of the base station information of the base station information storage unit 380, and may release the restriction of the WiFi, only when the service of the WiFi can be received.

As such, the restriction of the mobile network is released (for example, “WiFi priority”) during the stop at the station, so that a high-speed service based on the WiFi can be received, when the service of the WiFi is provided at the stop. In addition, the carrier can realize the traffic off-load.

[Control Example of WiFi when User Gets on Electric Train)

Recently, routes (for example, a Tokyo-ShinOsaka section of Tokaido Shinkansen) providing the WiFi service in the electric train increase. In this section (for example, the Tokyo-ShinOsaka section of Tokaido Shinkansen), even though the coverage of the WiFi is very narrow, a stable service can be received during the movement by the electric train. Therefore, in the section (for example, the Tokyo-ShinOsaka section of Tokaido Shinkansen), the restriction of the WiFi can be released while the wireless communication apparatus 300 moves by the electric train.

[Control Example of WiFi in Case in which Electric Trains of Same Type Run on Same Route]

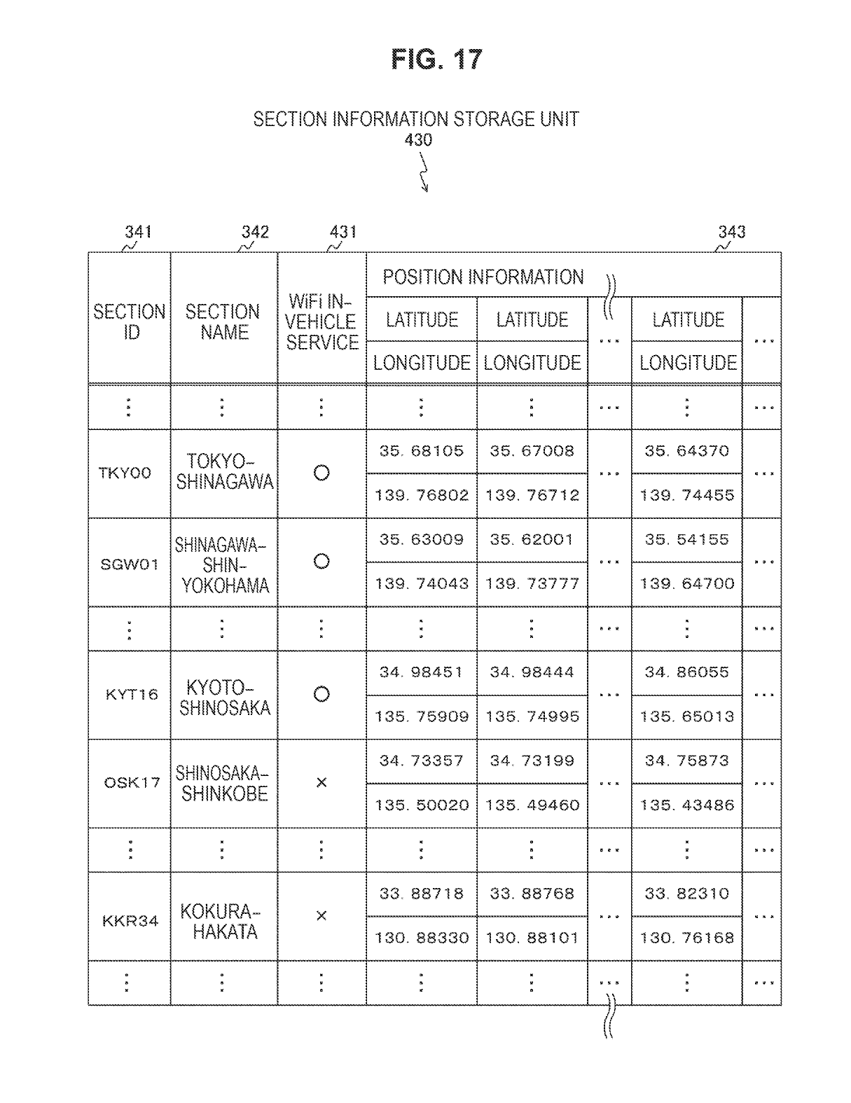

FIG. 17 is a diagram schematically illustrating an example of storage content of a section information storage unit 430 according to the third embodiment of the present disclosure. Because the section information storage unit 430 is obtained by changing a part of the section information storage unit 340 illustrated in FIG. 12, portions common to the section information storage unit 340 are denoted with the same reference numerals and explanation thereof is omitted.

In the section information storage unit 430, a section ID 341, a section name 342, position information 343, and a WiFi in-vehicle service 431 are associated and stored.

The WiFi in-vehicle service 431 is information showing whether the WiFi in-vehicle service can be received in a section between two stations (for example, a flag showing whether the WiFi in-vehicle service is enabled). In FIG. 17, “O” is added to a section where reception of the WiFi in-vehicle service is enabled and “x” is added to a section where the reception of the WiFi in-vehicle service is disabled.

For example, the case in which it is determined by the movement path specifying unit 370 that the user gets on Tokaido Shinkansen is assumed. In this case, when it is determined by the movement path specifying unit 370 that the wireless communication apparatus 300 moves between Tokyo and ShinOsaka, the control unit 151 confirms whether the WiFi in-vehicle service is enabled, using the section information storage unit 430. As illustrated in FIG. 17, the WiFi in-vehicle service can be received in a section between Tokyo and ShinOsaka. For this reason, the control unit 151 performs control to automatically switch the setting of the mobile network into the WiFi priority. That is, the same setting as “stop at the station” illustrated in a of FIG. 2 is performed.

Meanwhile, the case in which it is determined that the wireless communication apparatus 300 moves between ShinOsaka and ShinKobe is assumed. As illustrated in FIG. 17, the WiFi in-vehicle service may not be received in a section between ShinOsaka and ShinKobe. For this reason, the control unit 151 performs control to switch the setting of the mobile network into the priority of wireless communication services other than the WiFi. Here, other wireless communication services are, for example, the UMTS, the LTE, and the EV-DO. However, a high-speed service (for example, the LTE) is restricted while the Shinkansen moves.

[Control Example of WiFi in Case in which Electric Trains of Plurality of Types Run on Same Route]

As the example of the electric train that provides the WiFi in-vehicle service, the Shinkansen has been described. However, electric trains other than the Shinkansen that provide the WiFi in-vehicle service exist. For example, Narita Express provides the WiFi in-vehicle service in all sections. For this reason, when it is determined that the user gets on Narita Express and the wireless communication apparatus is moving, the setting of the mobile network can be automatically switched into the WiFi priority.

However, a route of Narita Express uses a route of Sobu Line between Tokyo and Chiba. For this reason, it is necessary to determine whether the user possessing the wireless communication apparatus 300 gets on the electric train (electric train other than Narita Express) of Sobu Line or gets on Narita Express. Therefore, in this example, the types of the electric trains are determined and the setting control of the WiFi is performed, when the electric trains of the plurality of types run on the same route.

[Control Example of WiFi in Case in which Electric Trains of Plurality of Types Run on Same Route]

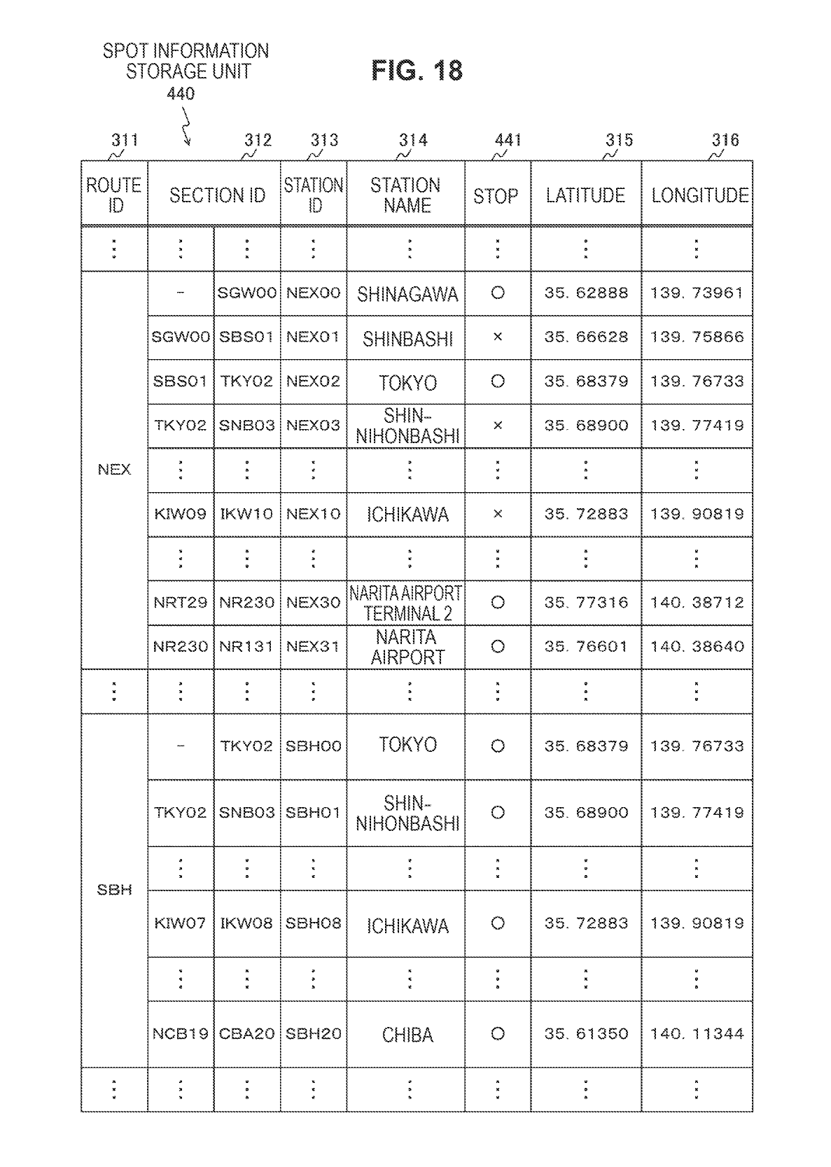

FIG. 18 is a diagram schematically illustrating an example of storage content of a spot information storage unit 440 according to the third embodiment of the present disclosure. The spot information storage unit 440 is obtained by changing a part of the spot information storage unit 310 illustrated in FIG. 11. For this reason, portions common to the spot information storage unit 310 are denoted with the same reference numerals and explanation thereof is omitted.

In the spot information storage unit 440, a route ID 311, a section ID 312, a station ID 313, a station name 314, a latitude 315, a longitude 316, and a stop 441 are associated and stored. A route ID 311 “NEX” shows a route of Narita Express and a route ID 311 “SBH” shows a route of Sobu Line. That is, in this example, even when routes include the same station or the same section, the routes are managed as different routes according to the types of the electric trains.

The stop 441 is information that shows whether the electric train stops at a station. In FIG. 18, “O” is added to a stop and “x” is added to a non-stop. For example, it can be determined that an Ichikawa station is not a stop of Narita Express, but is a stop of Sobu Line.

For example, the case in which it is determined by the movement path specifying unit 370 that the wireless communication apparatus 300 moves on the route of which the route ID 311 corresponds to “NEX” or “SBH” is assumed. In this case, when it is detected that the wireless communication apparatus 300 has stopped at the Ichikawa station, on the basis of a determination result by the movement type determining unit 130, the movement path specifying unit 370 specifies the movement path of the wireless communication apparatus 300 as Sobu Line. Meanwhile, when it is not detected that the wireless communication apparatus 300 has stopped at the Ichikawa station, the movement path specifying unit 370 specifies the movement path of the wireless communication apparatus 300 as Narita Express.

As such, the restriction of the mobile network is released (for example, “WiFi priority”) in an environment in which the mobile network can be used, so that a high-speed service using the mobile network can be received. In addition, the carrier can realize the traffic off-load.

The method of determining the plurality of paths using the same route is not limited to the above method and other methods may be used. For example, a method of storing information (necessary period information) regarding necessary times between stations in the section information storage unit and determining each path according to a difference of the necessary times may be used. For example, the necessary time of Narita Express is generally shorter than the necessary time of Sobu Line. For this reason, when the necessary times between the stations and the necessary time of Narita Express are approximately the same, the movement path is specified as Narita Express. Meanwhile, when the necessary times between the stations and the necessary time of Sobu Line are approximately the same, the movement path is specified as Sobu Line.

Also, a method of storing information regarding a departure time, an arrival time, and a passage time of each train at each station of each route in the section information storage unit and determining a type of each train according to a comparison of each time and a time acquired by the wireless communication apparatus 300 at each station may be used.

The in-vehicle mobile service is not limited to the WiFi and may be applied to WiMax or services of various communication methods based on a mobile base station mounted in the vehicle.

### 4. Fourth Embodiment

In the third embodiment of the present disclosure, the example of the case in which the determination of the type of the movement mechanism and the specification of the movement path are performed in the wireless communication apparatus and the base station selection process is restricted on the basis of the result has been described. However, the determination of the type of the movement mechanism of the wireless communication apparatus and the specification of the movement path may be performed in an apparatus (for example, an information processing apparatus) other than the wireless communication apparatus and the base station selection process of the wireless communication apparatus may be restricted on the basis of the result.

Therefore, in a fourth embodiment of the present disclosure, an example of the case in which the determination of the type of the movement mechanism and the specification of the movement path are performed in the information processing apparatus and the base station selection process of the wireless communication apparatus is restricted on the basis of the result will be described. A communication system according to the fourth embodiment of the present disclosure is obtained by changing a part of the communication system 200 illustrated in FIG. 6. For this reason, portions common to the communication system 200 are denoted with the same reference numerals and explanation thereof is omitted.

### [Configuration Example of Information Processing Apparatus]

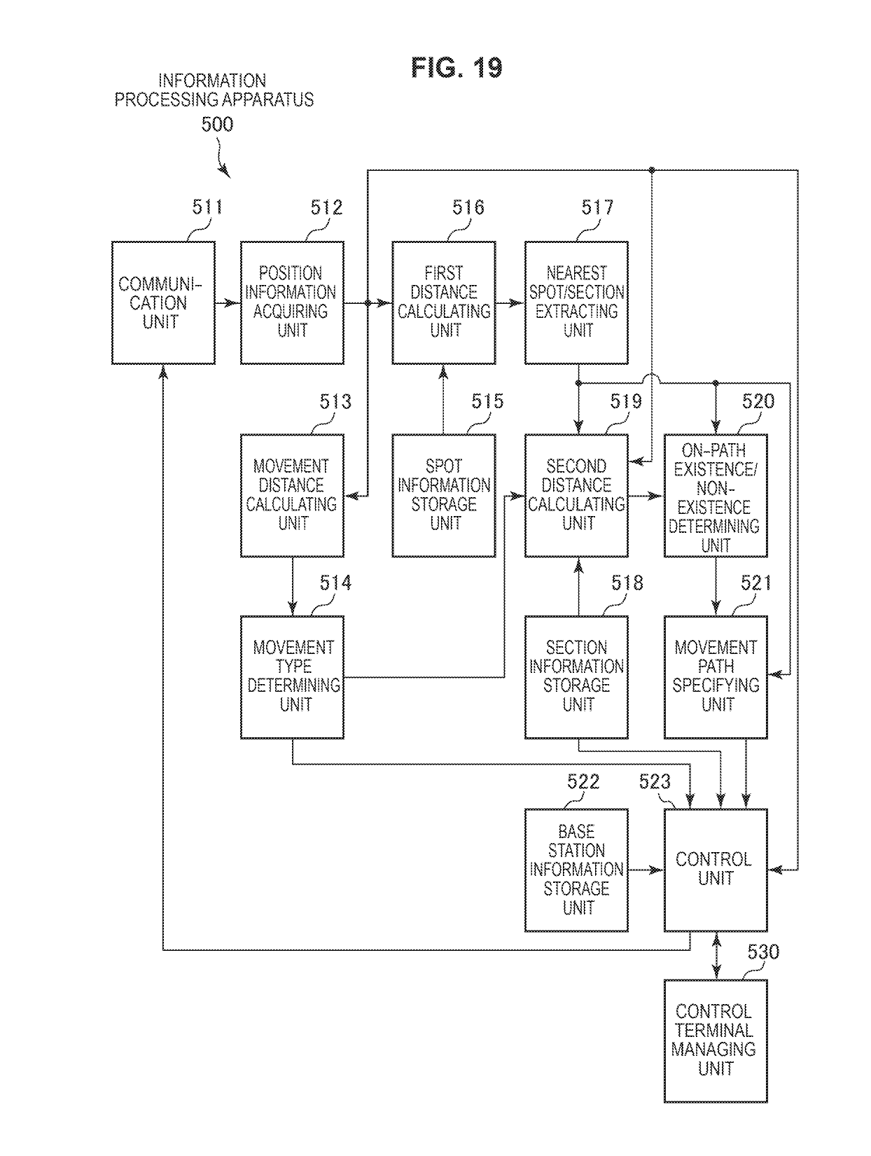

FIG. 19 is a block diagram illustrating a functional configuration example of an information processing apparatus 500 according to a fourth embodiment of the present disclosure.

The information processing apparatus 500 includes a communication unit 511, a position information acquiring unit 512, a movement distance calculating unit 513, a movement type determining unit 514, a spot information storage unit 515, a first distance calculating unit 516, and a nearest spot/section extracting unit 517. The information processing apparatus 500 further includes a section information storage unit 518, a second distance calculating unit 519, an on-path existence/non-existence determining unit 520, a movement path specifying unit 521, a base station information storage unit 522, a control unit 523, and a control terminal managing unit 530. The position information acquiring unit 512 to the base station information storage unit 522 correspond to individual units of the same names in the wireless communication apparatus 300 illustrated in FIG. 9. For this reason, the individual units common to the wireless communication apparatus 300 are described on the basis of a difference with the wireless communication apparatus 300 and the other explanation is omitted.

The communication unit 511 exchanges various information with the wireless communication apparatuses 240 and 251 to 253, through the base stations 231 and 232 managed by the carrier (carrier managing the communication control apparatus 230 illustrated in FIG. 6). For example, when the communication unit 511 receives position information from the wireless communication apparatus 240 and 251 to 253, the communication unit 511 transmits the received position information to the position information acquiring unit 512. In addition, the communication unit 511 transmits a control signal to restrict the base station selection process of the wireless communication apparatus to the wireless communication apparatus, on the basis of control of the control unit 523.

The control unit 523 performs control to restrict the base station selection process in the wireless communication apparatus that has transmitted the position information, through the communication unit 511. The control unit 523 corresponds to the control unit 151 illustrated in FIG. 9 and is different from the control unit 151 in that the control unit 523 performs control to restrict the base station selection process in other wireless communication apparatus.

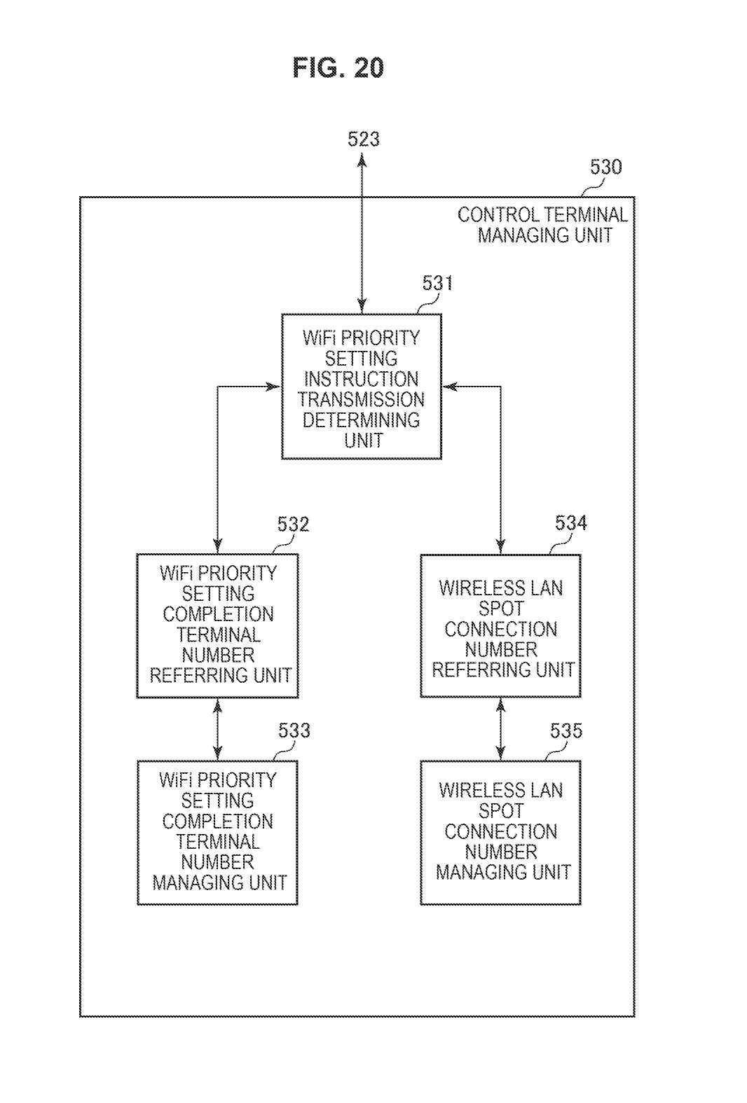

The control terminal managing unit 530 manages a wireless communication apparatus becoming a control target and supplies information (management information) regarding the wireless communication apparatus becoming the control target to the control unit 523. The control terminal managing unit 530 will be described in detail with reference to FIG. 20.

### [Configuration Example of Control Terminal Managing Unit]

FIG. 20 is a block diagram illustrating a functional configuration example of the control terminal managing unit 530 according to the fourth embodiment of the present disclosure.

The control terminal managing unit 530 includes a WiFi priority setting instruction transmission determining unit 531, a WiFi priority setting completion terminal number referring unit 532, and a WiFi priority setting completion terminal number managing unit 533. The control terminal managing unit 530 further includes a wireless LAN spot connection number referring unit 534 and a wireless LAN spot connection number managing unit 535.

The WiFi priority setting instruction transmission determining unit 531 determines whether WiFi priority setting is performed, on the basis of management content of the WiFi priority setting completion terminal number managing unit 533 and the wireless LAN spot connection number managing unit 535. In addition, the WiFi priority setting instruction transmission determining unit 531 outputs a determination result to the control unit 523.

The WiFi priority setting completion terminal number referring unit 532 refers to the number of terminals in which the WiFi priority setting managed by the WiFi priority setting completion terminal number managing unit 533 has been completed and outputs a reference result to the WiFi priority setting instruction transmission determining unit 531.

The WiFi priority setting completion terminal number managing unit 533 manages the number of terminals in which the WiFi priority setting has been completed and supplies management content to the WiFi priority setting completion terminal number referring unit 532.

The wireless LAN spot connection number referring unit 534 refers to the number of connections to a wireless LAN spot to be managed by the wireless LAN spot connection number managing unit 535 and outputs a reference result to the WiFi priority setting instruction transmission determining unit 531.

The wireless LAN spot connection number managing unit 535 manages the number of connections to the wireless LAN spot and supplies management content to the wireless LAN spot connection number referring unit 534.

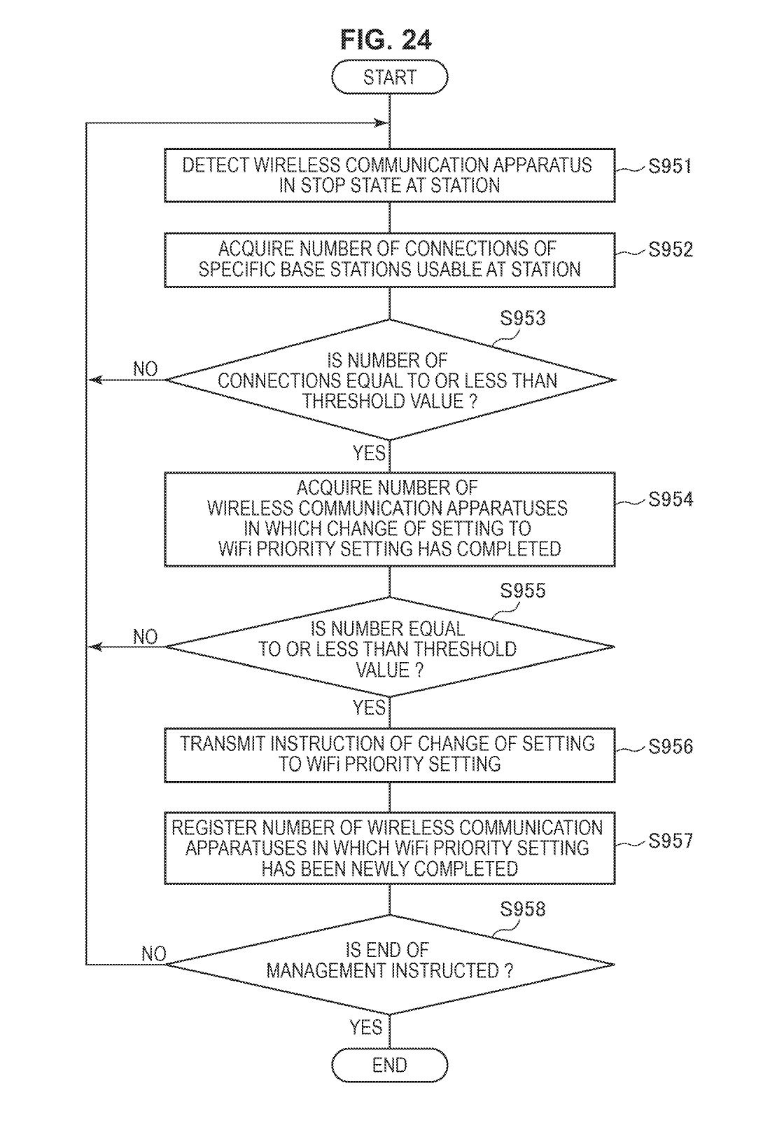

The process of each unit will be described in detail with reference to FIG. 24.

### [Communication Example]

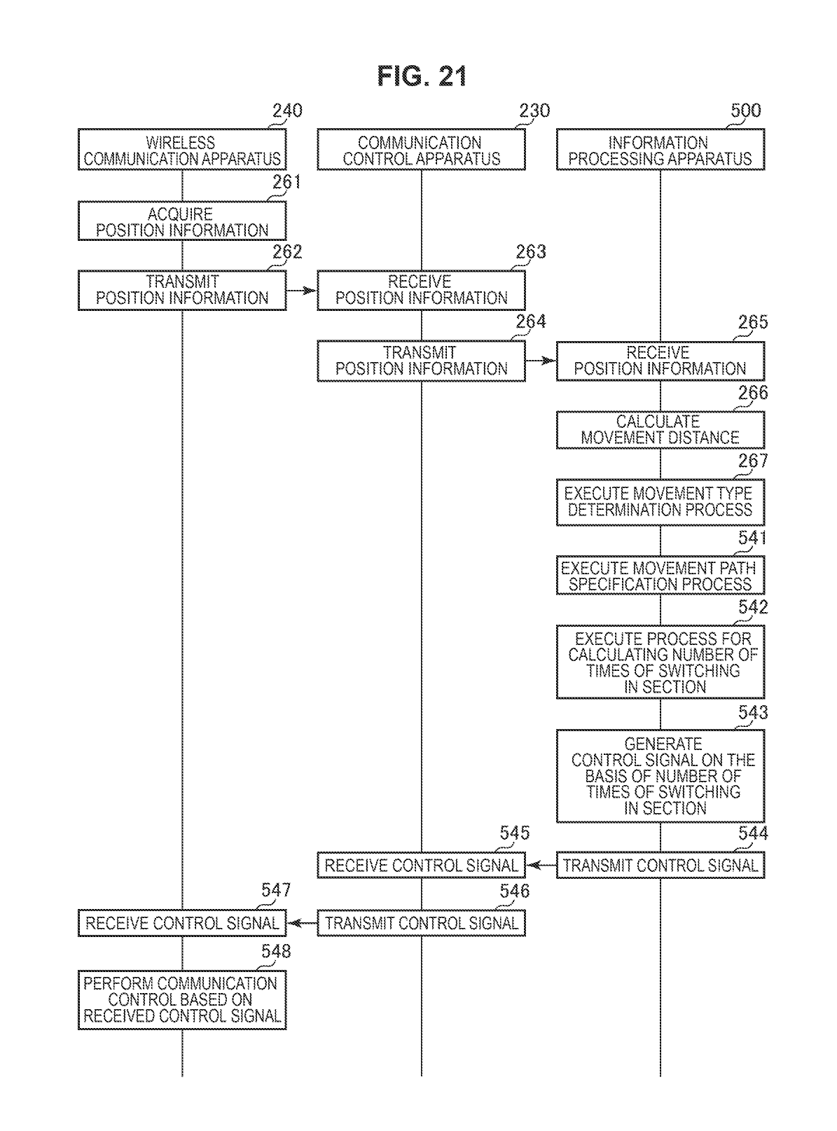

FIG. 21 is a sequence chart illustrating an example of a communication process between individual apparatuses constituting a communication system 200 according to the fourth embodiment of the present disclosure. FIG. 21 is obtained by changing a part of the communication example illustrated in FIG. 8. For this reason, portions common to FIG. 8 are denoted with the same reference numerals and explanation thereof is omitted.

After the type of the movement mechanism of the wireless communication apparatus 240 is determined (267), the movement path specifying unit 521 of the information processing apparatus 500 specifies the movement path of the wireless communication apparatus 240 (541). Next, the control unit 523 acquires the base station information in the specified movement path from the base station information storage unit 522 and calculates the number of times of switching in a section corresponding to the specified movement path, on the basis of the acquired base station information (542).

Next, the control unit 523 determines whether the calculated number of times of switching is less than a threshold value and generates a control signal to perform control regarding the base station selection process, on the basis of a determination result (543). For example, when the calculated number of times of switching is equal to or more than the threshold value, a control signal to put restrictions to execute only the processes such as the handover, the cell selection, and the cell reselection between the same communication systems in which the service regions of the cell sizes are large is generated. Meanwhile, when the calculated number of times of switching is less than the threshold value, a control signal to release the restriction of the base station selection process is generated, because the base station selection process is not restricted.

Next, the control unit 523 of the information processing apparatus 500 transmits the generated control signal to the wireless communication apparatus 240 through the communication control apparatus 230 (544 to 547). If the wireless communication unit 242 of the wireless communication apparatus 240 receives the control signal (547), the wireless communication unit 242 executes the wireless communication, on the basis of the control signal (548).

[Communication Example (Example of Case in which Restriction of Base Station Selection Process is Released at the Time of Stop at Station)

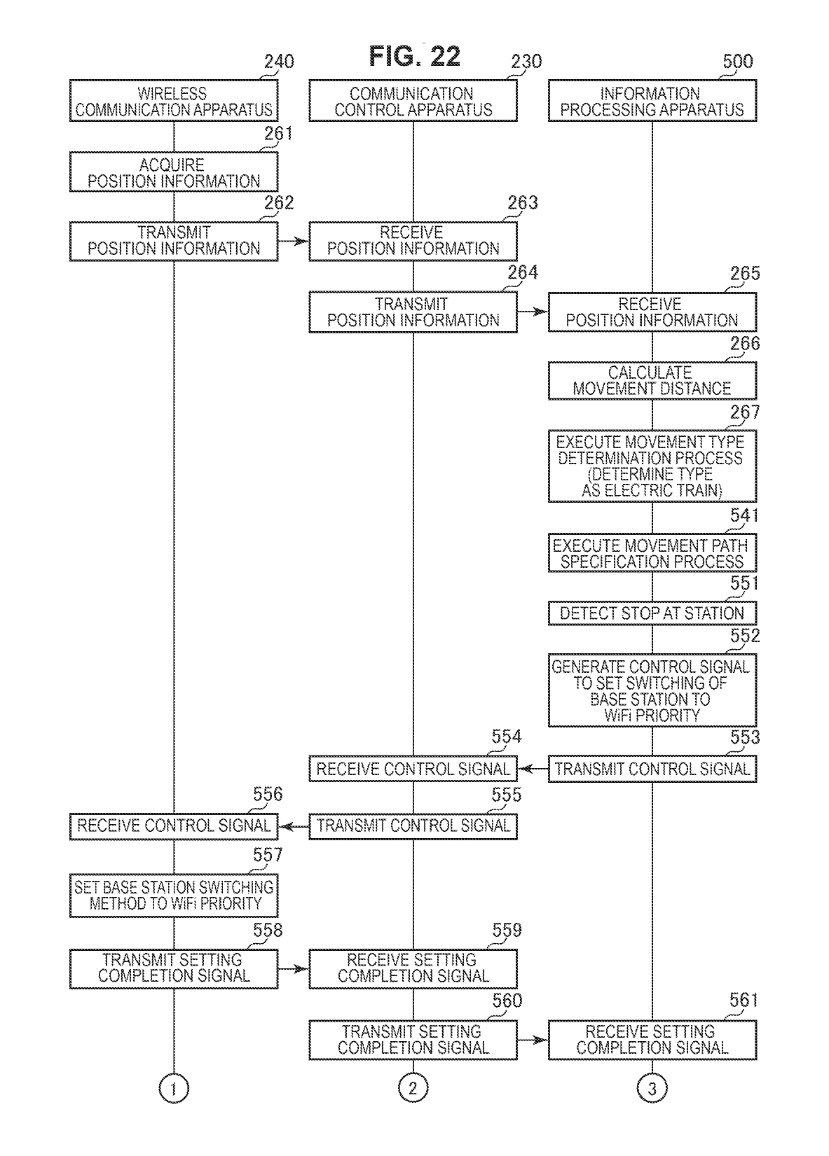

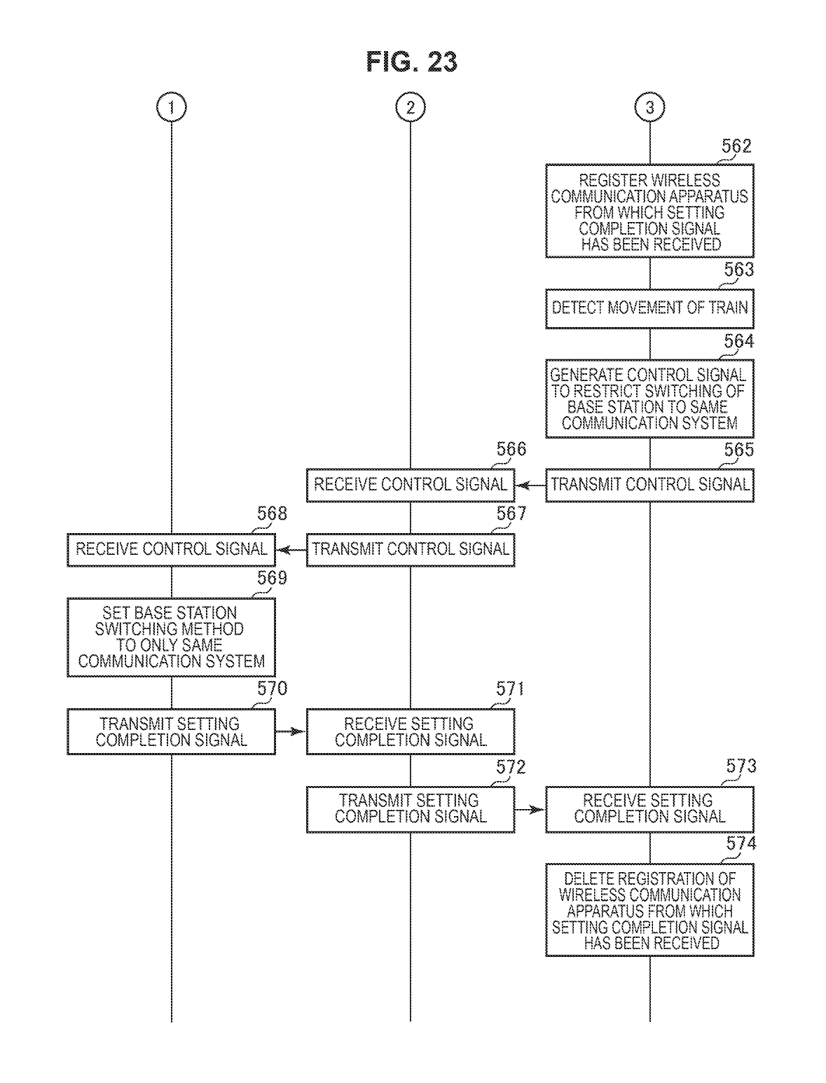

FIGS. 22 and 23 are sequence charts illustrating an example of a communication process between individual apparatuses constituting the communication system 200 according to the fourth embodiment of the present disclosure. In FIGS. 22 and 23, an example of the case in which the restriction of the base station selection process is released at the time of stop at the station and WiFi priority setting is performed is illustrated. FIGS. 22 and 23 are obtained by changing a part of the communication example illustrated in FIG. 21. For this reason, portions common to FIG. 21 are denoted with the same reference numerals and explanation thereof is omitted.

After the movement path of the wireless communication apparatus 240 is specified (541), the control unit 523 detects the stop at the station, on the basis of the determination result by the movement type determining unit 514 and the specification result by the movement path specifying unit 521 (551). As such, when the stop at the station is detected, the control unit 523 releases the restriction of the base station selection process and generates a control signal to perform the WiFi priority setting (552).

Next, the control unit 523 of the information processing apparatus 500 transmits the generated control signal to the wireless communication apparatus 240 through the communication control apparatus 230 (553 to 556). If the wireless communication unit 242 of the wireless communication apparatus 240 receives the control signal (556), the wireless communication unit 242 performs the WiFi priority setting, on the basis of the control signal (557).

Next, the wireless communication unit 242 transmits a signal (setting completion signal) showing that the WiFi priority setting has been completed to the information processing apparatus 500 through the communication control apparatus 230 (558 to 561). When the setting completion signal is received (561), the control unit 523 of the information processing apparatus 500 registers the wireless communication apparatus 240 in the WiFi priority setting completion terminal number managing unit 533 of the control terminal managing unit 530 (562).

The control unit 523 detects the movement of the train, on the basis of the determination result by the movement type determining unit 514 and the specification result by the movement path specifying unit 521 (563). As such, when the movement of the train is detected, the control unit 523 generates a control signal to restrict the base station selection process (564).

Next, the control unit 523 of the information processing apparatus 500 transmits the generated control signal to the wireless communication apparatus 240 through the communication control apparatus 230 (565 to 568). If the wireless communication unit 242 of the wireless communication apparatus 240 receives the control signal (568), the wireless communication unit 242 performs setting to restrict the base station selection process, on the basis of the control signal (569).

Next, the wireless communication unit 242 transmits a signal (setting completion signal) showing that the setting to restrict the base station selection process has been completed to the information processing apparatus 500 through the communication control apparatus 230 (570 to 573). When the setting completion signal is received (573), the control unit 523 of the information processing apparatus 500 deletes the registration of the wireless communication apparatus 240 from the WiFi priority setting completion terminal number managing unit 533 of the control terminal managing unit 530 (574).

In FIGS. 22 and 23, the example of the case in which the restriction of the base station selection process is released and the WiFi priority setting is performed at the time of stop at the station is illustrated. However, if the restrictions of all of the targeted wireless communication apparatuses are released and the WiFi priority setting is performed at the time of the stop at the station, the number of connections of the WiFi to the base station may increase and a high-speed service may not be appropriately received. Therefore, the restrictions of only a part of the targeted wireless communication apparatuses are released and the WiFi priority setting is performed at the time of the stop at the station.

### [Operation Example of Information Processing Apparatus]

FIG. 24 is a flowchart illustrating an example of a process sequence of a base station selection process control process of the information processing apparatus 500 according to the fourth embodiment of the present disclosure.

First, the control unit 523 detects the wireless communication apparatus in a stop state at the station, on the basis of the determination result by the movement type determining unit 514 and the specification result by the movement path specifying unit 521 (step S951). Next, the WiFi priority setting instruction transmission determining unit 531 of the control terminal managing unit 530 acquires the number of connections to a wireless LAN spot usable at the station (step S952). That is, the WiFi priority setting instruction transmission determining unit 531 acquires the number of connections to the wireless LAN spot usable at the station, from the wireless LAN spot connection number managing unit 535, through the wireless LAN spot connection number referring unit 534.

Next, the WiFi priority setting instruction transmission determining unit 531 determines whether the number of connections to the wireless LAN spot usable at the station is equal to or less than a threshold value (step S953). When the number of connections is more than the threshold value (step S953), if a further connection is performed, a high-speed service may not be appropriately received. For this reason, the WiFi priority setting instruction transmission determining unit 531 returns to step S951.

Meanwhile, when the number of connections is equal to or less than the threshold value (step S953), the WiFi priority setting instruction transmission determining unit 531 acquires the number of wireless communication apparatuses (number of terminals) in which the change of the setting to the WiFi priority setting has been completed (step S954). That is, the WiFi priority setting instruction transmission determining unit 531 acquires the number of terminals in which the change of the setting to the WiFi priority setting has been completed at the station, from the WiFi priority setting completion terminal number managing unit 533, through the WiFi priority setting completion terminal number referring unit 532.

Next, the WiFi priority setting instruction transmission determining unit 531 determines whether the number of terminals in which the change of the setting to the WiFi priority setting has been completed at the station is equal to or less than a threshold value (step S955). When the number of terminals is more than the threshold value (step S955), if a further connection is performed, a high-speed service may not be appropriately received. For this reason, the WiFi priority setting instruction transmission determining unit 531 returns to step S951.

Meanwhile, when the number of terminals is equal to or less than the threshold value (step S955), the WiFi priority setting instruction transmission determining unit 531 instructs a wireless communication apparatus in which the stop at the station has been newly detected to change the setting to the WiFi priority setting (step S956). In this case, the control unit 523 transmits a control signal to instruct the change of the setting to the WiFi priority setting to the wireless communication apparatus (step S956).

Next, the WiFi priority setting instruction transmission determining unit 531 registers the wireless communication apparatus in which the WiFi priority setting has been newly completed in the WiFi priority setting completion terminal number managing unit 533, through the WiFi priority setting completion terminal number referring unit 532 (step S957). The registration may be performed under a condition in which the setting completion signal has been received, as illustrated in FIGS. 22 and 23. When the setting is released, the registration is deleted.

Next, it is determined whether the end of the management is instructed (step S958). When the end of the management is not instructed, the process returns to step S951. Meanwhile, when the end of the management is instructed (step S958), the operation of the base station selection process control process ends.

Here, the case in which the load is applied reversely to the base station after switching when the wireless communication apparatuses of passengers are switched at all once at the stop is assumed. Therefore, in this example, the control terminal managing unit 530 instructs WiFi priority setting and manages the number of wireless communication apparatuses in which setting has been completed. Thereby, the number of terminals connected to the WiFi base station (access point) at the station can be controlled to a constant number and a high-speed service can be stably provided.

The control terminal managing unit 530 may dynamically acquire the number of terminals connected to the WiFi base station (access point) and may appropriately instruct the wireless communication apparatus detected as the wireless communication apparatus in a stop state at the station to perform the WiFi priority setting, on the basis of the number of terminals.

In addition, the control terminal managing unit 530 may dynamically acquire the number of connections to the base station providing a high-speed service such as the LTE and the WiMAX and may instruct the WiFi priority setting according to the number of connections.

As such, in the fourth embodiment of the present disclosure, the wireless communication apparatus 240 performs the acquisition of the position information and the transmission of the position information and the information processing apparatus 500 performs control regarding the base station selection process in the wireless communication apparatus, on the basis of the information. For this reason, load of each process in the wireless communication apparatus 240 can be greatly alleviated and consumption power can be effectively used. At the time of stop at the station, the restriction of the base station selection process is released in consideration of a use situation of a high-speed service, so that the high-speed service can be stably provided.

The wireless LAN spot is not limited to the access point of the WiFi and widely includes a femtocell and a picocell corresponding to the UMTS, the LTE, and the LTE-Advanced.

### 5. Fifth Embodiment

In the first to fourth embodiments of the present disclosure, the example of the case in which the base station selection process is restricted has been described. Here, information regarding the movement path of the wireless communication apparatus is provided to a user, so that the user can easily know a movement history (for example, a life log or time-series position information) of the user.

Therefore, in the fifth embodiment of the present disclosure, an example of the case in which various information regarding the movement path of the wireless communication apparatus is provided to the user is illustrated.

### [Configuration Example of Wireless Communication Apparatus]

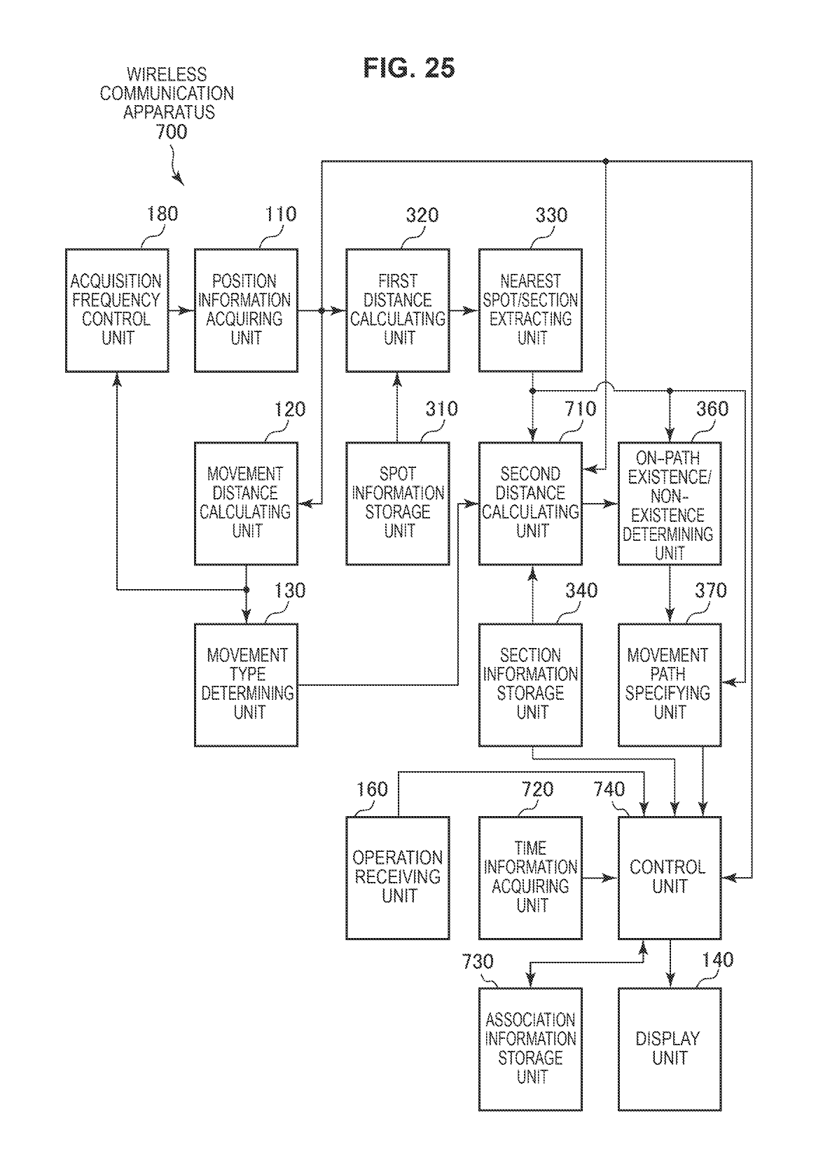

FIG. 25 is a block diagram illustrating a functional configuration example of a wireless communication apparatus 700 according to a fifth embodiment of the present disclosure. The wireless communication apparatus 700 is obtained by changing a part of the wireless communication apparatus 300 illustrated in FIG. 9. For this reason, portions common to the wireless communication apparatus 300 are denoted with the same reference numerals and explanation thereof is omitted.

The wireless communication apparatus 700 includes a second distance calculating unit 710, a time information acquiring unit 720, an association information storage unit 730, and a control unit 740.

The second distance calculating unit 710 calculates a distance (second distance) of a position (position where the wireless communication apparatus 300 exists) specified by the position information acquired by the position information acquiring unit 110 and the section extracted by the nearest spot/section extracting unit 330. In this case, the second distance calculating unit 710 acquires the section information stored in the section information storage unit 340, on the basis of the type of the movement mechanism determined by the movement type determining unit 130, and calculates a distance with respect to the path.

For example, when it is determined by the movement type determining unit 130 that the type of the movement mechanism is the electric train, only information associated with the route of the electric train is acquired from the section information storage unit 340. When it is determined by the movement type determining unit 130 that the type of the movement mechanism is the vehicle (for example, a route bus), only information associated with a road is acquired from the section information storage unit 340. In addition, the second distance calculating unit 710 calculates a distance (second distance) of the position where the wireless communication apparatus 300 exists and the section extracted by the nearest spot/section extracting unit 330.

The time information acquiring unit 720 acquires information (time information (for example, a current time)) regarding a time and supplies the acquired time information to the control unit 740.

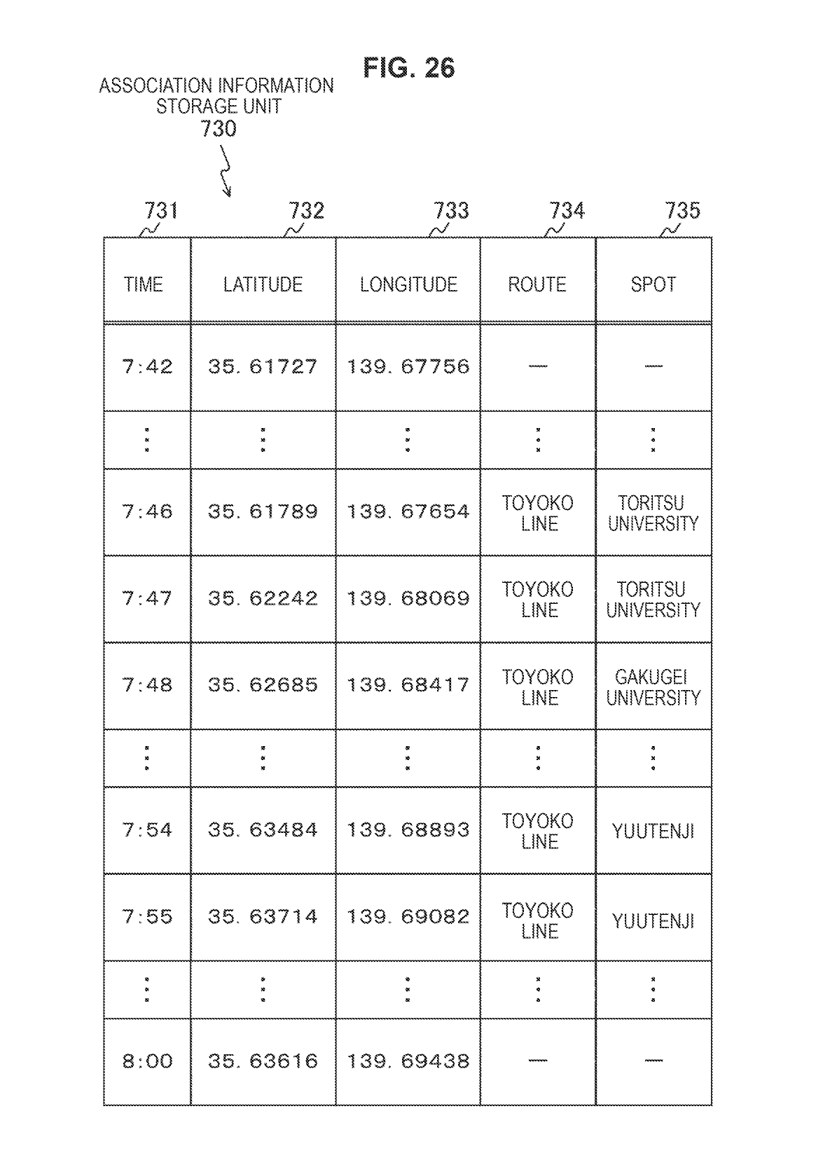

The association information storage unit 730 associates each information acquired in the wireless communication apparatus 700 and stores the information. The association information storage unit 730 supplies the stored information (association information) to the control unit 740. Storage content of the association information storage unit 730 will be described in detail with reference to FIG. 26.

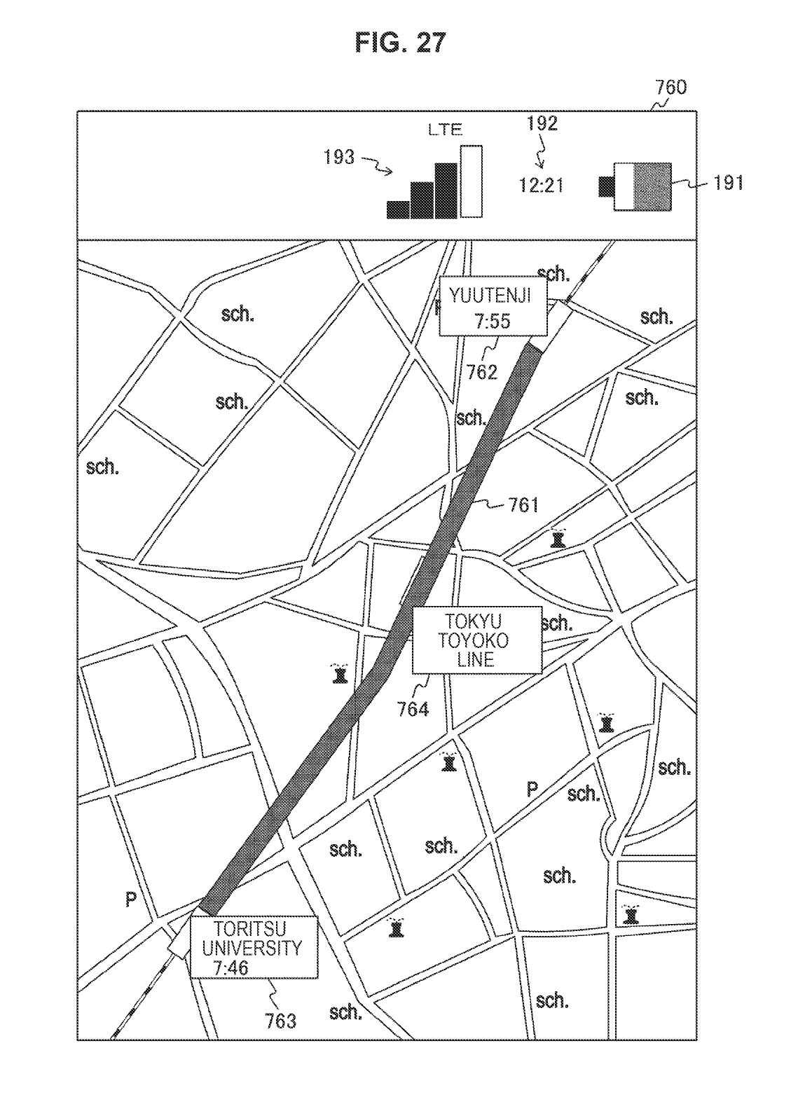

The control unit 740 performs control to associate the position information acquired by the position information acquiring unit 110, the information (path information) regarding the movement path specified by the movement path specifying unit 370, and the time information acquired by the time information acquiring unit 720. Here, the path information is section information that is stored in the section information storage unit 340 (information regarding a section corresponding to the movement path specified by the movement path specifying unit 370). The control unit 740 records the associated information in the association information storage unit 730. In addition, the control unit 740 displays the associated information on the display unit 170. A display example is illustrated in FIG. 27.

### [Example of Storage Content of Association Information Storage Unit]

FIG. 26 is a diagram schematically illustrating an example of storage content of the association information storage unit 730 according to the fifth embodiment of the present disclosure.

In the association information storage unit 730, a time 731, a latitude 732, a longitude 733, a route 734, and a spot 735 are associated and stored.

The time information that is acquired by the time information acquiring unit 720 is stored in the time 731.

The position information that is acquired by the position information acquiring unit 110 is stored in the latitude 732 and the longitude 733.

A name of a route corresponding to the movement path specified by the movement path specifying unit 370 (route specified by the section information stored in the section information storage unit 340) is stored in the route 734.

A name of a spot corresponding to the movement path specified by the movement path specifying unit 370 (spot specified by the section information stored in the section information storage unit 340) is stored in the spot 735.

For example, the case in which a user of the wireless communication apparatus 700 gets on from the Toritsu University station of Tokyu Toyoko Line at “7:46” and gets off at the “Yuutenji station” at “7:55” is assumed. In this case, a latitude and a longitude regarding a position where the user of the wireless communication apparatus 700 exists are associated with time information and an association result is stored in the latitude 732 and the longitude 733. In addition, “Tokyu Toyoko Line” is stored in the route 734. In addition, any one of the “Toritsu University” station and the “Yuutenji” station to be the nearest stations is stored in the spot 735, according to the position where the user of the wireless communication apparatus 700 exists. That is, a station name of “Tokyu Toyoko Line” nearest to the position where the user of the wireless communication apparatus 700 exists is stored in the spot 735.

As such, in the association information storage unit 730, log information of a certain user during any period is held in time series (for example, an interval of one minute).

For example, the case in which the user of the wireless communication apparatus 700 uses the route bus is assumed. In this case, the latitude and the longitude regarding the position where the user of the wireless communication apparatus 700 exists are associated with time information and an association result is stored in the latitude 732 and the longitude 733. In addition, a name of a route bus is stored in the route 734. In addition, a nearest bus stop is stored in the spot 735, according to the position where the user of the wireless communication apparatus 700 exists. That is, a bus stop (bus stop on a service route of a bus being used by the user) nearest to the position where the user of the wireless communication apparatus 700 exists is stored in the spot 735.

For example, the case in which the user of the wireless communication apparatus 700 uses an expressway (for example, “Tokyo-Nagoya Expressway”) (for example, the user drives a vehicle or uses an express bus) is assumed. In this case, the latitude and the longitude regarding the position where the user of the wireless communication apparatus 700 exists are associated with time information and an association result is stored in the latitude 732 and the longitude 733. In addition, a name “Tokyo-Nagoya Expressway” of the expressway is stored in the route 734. In addition, names of a nearest interchange, a nearest service area, and a nearest parking area are stored in the spot 735, according to the position where the user of the wireless communication apparatus 700 exists. That is, names of facilities on the expressway nearest to the position where the user of the wireless communication apparatus 700 exists are stored in the spot 735.

[Example of Case in which Association Information is Displayed]

FIG. 27 is a diagram illustrating an example (display screen 760) of a display screen that is displayed on a display unit 170 according to the fifth embodiment of the present disclosure. In FIG. 27, an example of a display screen that is displayed on the display unit 170 on the basis of association information stored in the association information storage unit 730 illustrated in FIG. 26 is illustrated.

The display screen 760 is a display screen that is displayed on the basis of the control of the control unit 740, when a predetermined user operation is performed. Each information in an upper display region of the display screen 760 is the same as the example illustrated in FIG. 3.

In an association information display region of the display screen 760, a map regarding association information that becomes a display target is displayed. On the map, path information 761 and a name 764 thereof and spot information 762 and 763 are overlapped and displayed.

The path information 761 and the name 764 thereof are a movement path specified by the movement path specifying unit 370 and a name thereof and are displayed on the basis of the route 734 illustrated in FIG. 26. As illustrated in FIG. 27, an effect of a color different from colors of other sections can be given to the path information 761.

The spot information 762 and 763 are names showing each spot on the movement path specified by the movement path specifying unit 370 and are displayed on the basis of the spot 735 illustrated in FIG. 26. As illustrated in FIG. 27, a name showing each spot and a time may be displayed in the spot information 762 and 763. The time is displayed on the basis of the time 731 illustrated in FIG. 26.

As such, a route name “Tokyu Toyoko Line”, an entraining station name “Toritsu University”, an entraining time “7:46”, a departing station name “Yuutenji”, and a departing time “7:55” can be automatically displayed on the basis of the movement history of the user.

The display may be performed in real time. For example, when getting on a train is detected, the route name “Tokyu Toyoko Line”, the entraining station name “Toritsu University”, and the entraining time “7:46” are displayed on the map. Next, a moving trace is visually and dynamically displayed on the map, according to the movement of the wireless communication apparatus 700. When getting off is detected, the departing station name “Yuutenji” and the departing time “7:55” can be displayed.

In FIG. 27, the example of the case in which only the entraining station and the departing station are displayed as the spot information is illustrated. However, each non-stop station may be displayed. The control unit 740 may calculate a necessary time between the entraining station and the departing station by subtracting the time information in the entraining station from the time information in the departing station and display the entraining time, the departing time, and the necessary time. Also, the control unit 740 may display only the necessary time.

The control unit 740 may display the entraining time at the time of entraining, display the time information for each stop (for example, a non-stop station) whenever the train stops at each station (or the train passes each station), and display the departing time at the time of departing, in time series. Here, the entraining time, each stop, the time information for the non-stop station, and the departing time may be not displayed and only the necessary time may be displayed.

The display example illustrated in FIG. 27 is only exemplary, the present disclosure is not limited to the display example, and display may be performed according to a different display aspect. For example, only information of the latitude and the longitude of the time series may be displayed on the map. In addition, icon display and display using a widget may be performed. The display using the widget is a method of displaying a small window on an upper right side of a display screen and displaying a route name, an entraining station name, an entraining time, a departing station name, and a departing time on the small window.

### [Operation Example of Wireless Communication Apparatus]

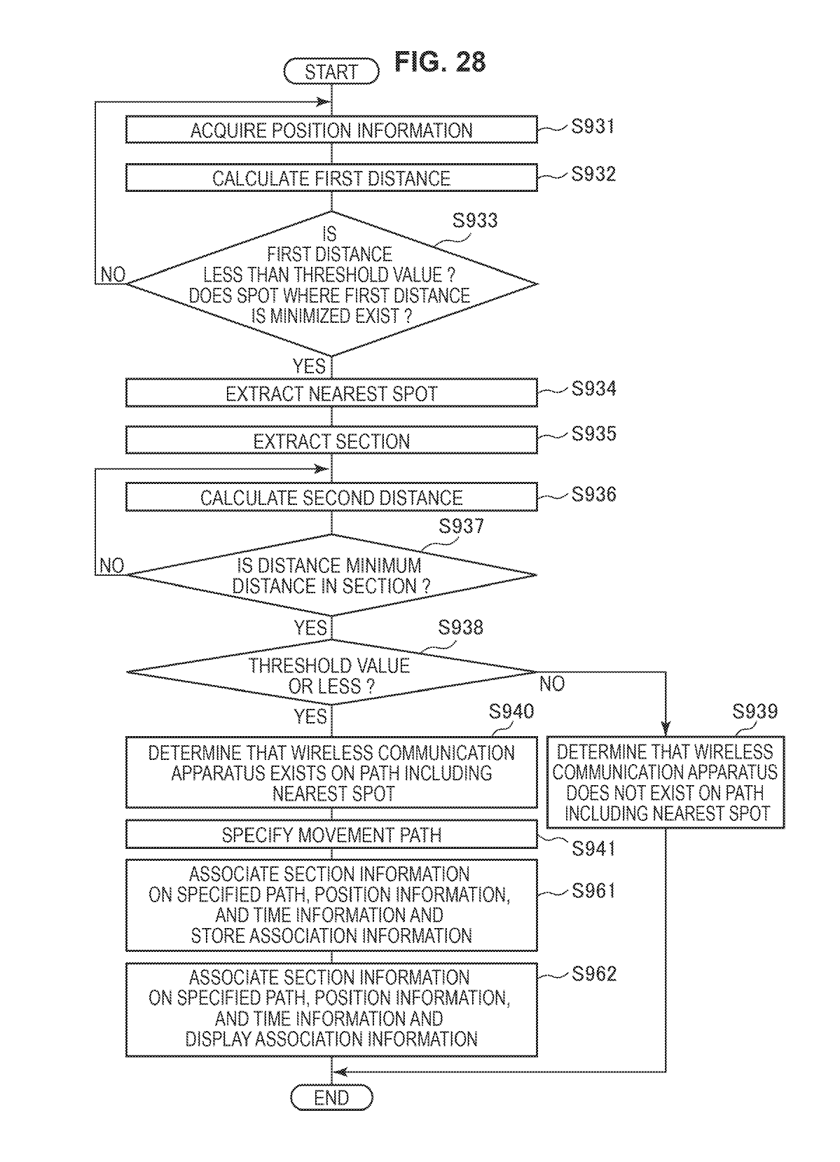

FIG. 28 is a flowchart illustrating an example of a process sequence of a display process of the wireless communication apparatus 700 according to the fifth embodiment of the present disclosure. FIG. 28 is obtained by changing a part of FIG. 15. For this reason, portions common to FIG. 15 are denoted with the same reference numerals and explanation thereof is omitted.

The control unit 740 associates the position information acquired by the position information acquiring unit 110, the information (path information) regarding the movement path specified by the movement path specifying unit 370, and the time information acquired by the time information acquiring unit 720 (step S961). In addition, the control unit 740 records the associated information (association information) in the association information storage unit 730 (step S961).

Next, the control unit 740 displays each information on the display unit 170, on the basis of the association information stored in the association information storage unit 730 (step S962). For example, each information is displayed as illustrated in FIG. 27.

In FIG. 28, the example of the case in which the information (association information) in which each information is associated is recorded in the association information storage unit 730 and each information is displayed on the basis of the association information stored in the association information storage unit 730 is illustrated. However, display based on the association information may be performed in real time.

As such, in the fifth embodiment of the present disclosure, the position information, the path information, and the time information can be associated and displayed. For example, a history and current information can be displayed in real time. For example, when the user watches a memory of a trip in a house, only the history can be displayed. Thereby, the user can easily know various information (movement history (for example, a life log or time-series position information)) regarding the movement path of the wireless communication apparatus.

### 6. Sixth Embodiment

In the fifth embodiment of the present disclosure, the example of the case in which the association of each information is performed in the wireless communication apparatus and the association information is displayed has been described. However, the association of each information may be performed in an apparatus (for example, an information processing apparatus) other than the wireless communication apparatus and the association information may be provided to the wireless communication apparatus.

Therefore, in the sixth embodiment of the present disclosure, an example of the case in which the association of each information is performed in the information processing apparatus and the association information is displayed on the wireless communication apparatus will be described. A communication system according to the sixth embodiment of the present disclosure is obtained by changing a part of the communication system 200 illustrated in FIG. 6. For this reason, portions common to the communication system 200 are denoted with the same reference numerals and explanation thereof is omitted.

### [Configuration Example of Information Processing Apparatus]

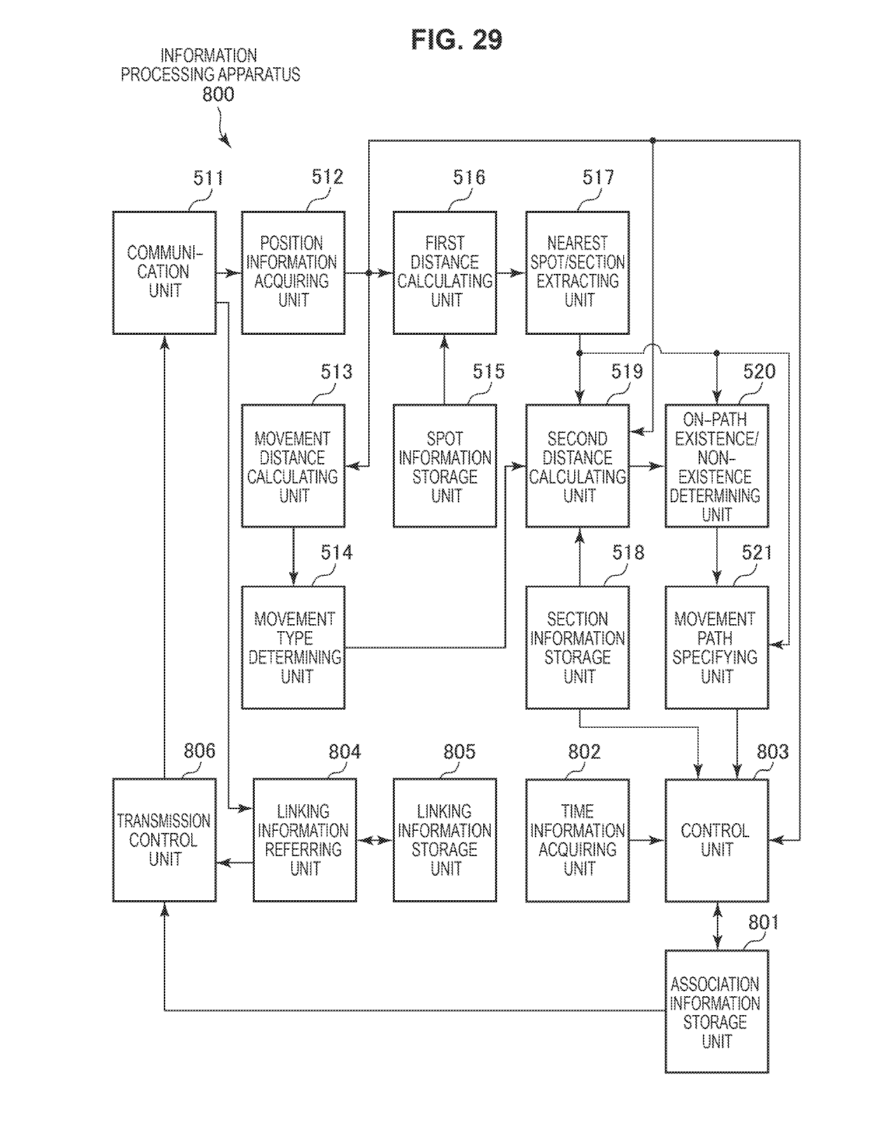

FIG. 29 is a block diagram illustrating a functional configuration example of an information processing apparatus 800 according to a sixth embodiment of the present disclosure. The information processing apparatus 800 is obtained by changing a part of the information processing apparatus 500 illustrated in FIG. 19. For this reason, portions common to the information processing apparatus 500 are denoted with the same reference numerals and explanation thereof is omitted.

The information processing apparatus 800 includes an association information storage unit 801, a time information acquiring unit 802, a control unit 803, a linking information referring unit 804, a linking information storage unit 805, and a transmission control unit 806.

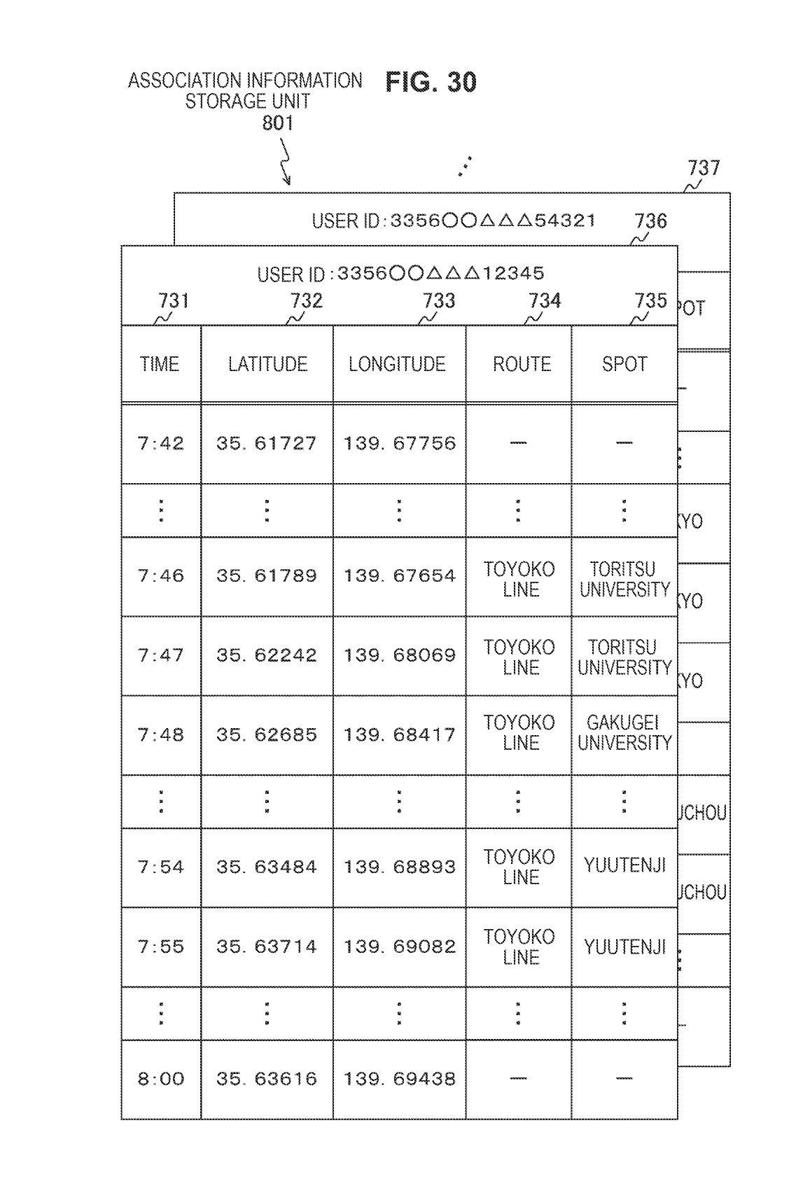

The association information storage unit 801 associates each information generated in each wireless communication apparatus for each wireless communication apparatus and stores the information and supplies the stored information (association information) to the control unit 803. Storage content of the association information storage unit 801 will be described in detail with reference to FIG. 30.

The time information acquiring unit 802 acquires information (time information (for example, a current time)) regarding a time and supplies the acquired time information to the control unit 803.

The control unit 803 performs control to associate the position information acquired by the position information acquiring unit 512, the information (path information) regarding the movement path specified by the movement path specifying unit 521, and the time information acquired by the time information acquiring unit 802. In this case, the control unit 803 associates the association information regarding each wireless communication apparatus for each wireless communication apparatus (or for each user) and records the information in the association information storage unit 801.

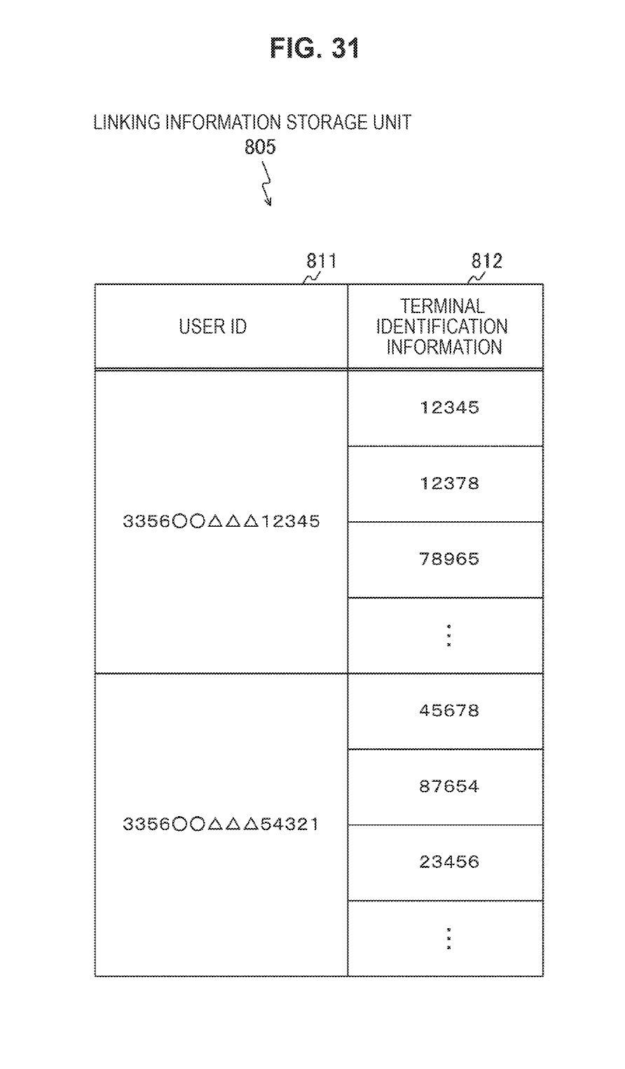

When the linking information referring unit 804 receives an information acquisition request (acquisition request of log information) from the wireless communication apparatus through the communication unit 511, the linking information referring unit 804 acquires a user ID (linking information) associated with the wireless communication apparatus that has transmitted the information acquisition request. Specifically, the linking information referring unit 804 extracts terminal identification information corresponding to the wireless communication apparatus that has transmitted the information acquisition request, from terminal identification information 812 (illustrated in FIG. 31) stored in the linking information storage unit 805. In addition, the linking information referring unit 804 acquires the user ID associated with the extracted terminal identification information. In addition, the linking information referring unit 804 outputs the acquired user ID to the transmission control unit 806.

The linking information storage unit 805 associates the user ID and the terminal identification information and stores an association result. Storage content of the linking information storage unit 805 will be described in detail with reference to FIG. 31.

The transmission control unit 806 performs control to transmit the association information stored in the association information storage unit 801 to the wireless communication apparatus, on the basis of the user ID acquired by the linking information referring unit 804. Specifically, the transmission control unit 806 acquires the association information that is stored in the association information storage unit 801 in association with the user ID acquired by the linking information referring unit 804. In addition, the transmission control unit 806 transmits the acquired association information to the wireless communication apparatus that has transmitted the information acquisition request, through the communication unit 511. Thereby, the wireless communication apparatus that has transmitted the information acquisition request can display the association information stored in the association information storage unit 801 on the display unit. For example, the association information can be displayed, similar to the display example illustrated in FIG. 27.

As such, the transmission control unit 806 can associate the specified movement path and the position information regarding the wireless communication apparatus in the specified movement path and display an association result on the wireless communication apparatus. The transmission control unit 806 is an example of a control unit (control unit that associates the specified movement path and the position information regarding the wireless communication apparatus in the specified movement path and displays an association result on the wireless communication apparatus) according to an embodiment of the present disclosure.

Here, association of each information regarding a user who uses two or more terminals will be described. For example, the case in which one user possesses two or more wireless communication apparatuses is considered. In this case, if the user carries the two wireless communication apparatuses at the same time at all times, the same log can be acquired from the viewpoint of acquiring a life log. That is, when a history of a log is read, the same log is acquired even if the log of either wireless communication apparatus is read.

Meanwhile, the case in which a user who changes the carrying wireless communication apparatus day by day reads a log acquired by each wireless communication apparatus is assumed. For example, the case in which one subscriber identity module (SIM) card is mounted to two or more wireless communication apparatus in which an SIM lock is released and is used separately is assumed. In this case, authentication and approval to read a log can be performed using a unique ID number stored in the SIM card. Thereby, the user can securely read the entire logs acquired by the two or more wireless communication apparatuses. In addition, the same structure can be applied to the case in which a software downloadable SIM is used for two or more wireless communication apparatuses.

Next, the case in which two or more wireless communication apparatuses are used separately using a plurality of SIM cards is considered. In this case, it is necessary to link a plurality of IDs stored in the plurality of SIM cards. For example, linking of ID information stored in the plurality of SIM cards to be used can be performed using one piece of user information (for example, a user ID and a password). By the linking, all log information associated with entire bound ID information can be securely read on the basis of the ID information stored in any SIM card. Here, the unique ID is, for example, an international mobile subscriber identity (IMSI) or an international mobile equipment identity (IMEI). In addition, the unique ID is, for example, a mobile station identification number (MSIN).

Therefore, in the sixth embodiment of the present disclosure, an example of the case in which the association information stored in the association information storage unit 801 is managed for each user will be described.

### [Example of Storage Content of Association Information Storage Unit]

FIG. 30 is a diagram schematically illustrating an example of storage content of an association information storage unit 801 according to the sixth embodiment of the present disclosure.

In the association information storage unit 801, a time 731, a latitude 732, a longitude 733, a route 734, and a spot 735 are associated and stored for each user ID. In FIG. 30, a storage example for two users 736 and 737 is illustrated. Because the time 731, the latitude 732, the longitude 733, the route 734, and the spot 735 are the same as those of FIG. 26, explanation thereof is omitted.

### [Example of Storage Content of Linking Information Storage Unit]

FIG. 31 is a diagram schematically illustrating an example of storage content of the linking information storage unit 805 according to the sixth embodiment of the present disclosure.

In the linking information storage unit 805, a user ID 811 and terminal identification information 812 are associated and stored.

The user ID 811 is user identification information that is provided for each registered user.

The terminal identification information 812 is terminal identification information that is provided to the registered terminal.

For example, a plurality of wireless communication apparatuses possessed by a user are registered in the information processing apparatus 800 (stored in the terminal identification information 812 of the linking information storage unit 805), so that a movement history of the user can be known at the same time, even though the user carries only any wireless communication apparatus.

As such, in the sixth embodiment of the present disclosure, each wireless communication apparatus can perform the acquisition of the position information and the transmission of the position information and the information processing apparatus 800 can associate the position information, the path information, and the time information and display the information on the wireless communication apparatus. Thereby, the user can easily know various information (movement history (for example, a life log or time-series position information)) regarding the movement path of the wireless communication apparatus. In addition, load of each process in each wireless communication apparatus can be greatly alleviated and consumption power can be effectively used.

In the fifth and sixth embodiments of the present disclosure, the example of the case in which the association information is displayed on the display unit of the wireless communication apparatus has been described. However, the association information may be output from a sound output unit (for example, a speaker) of the wireless communication apparatus. For example, a sound message showing “a most recently recorded path is Tokyu Toyoko Line, an entraining station is Toritsu University, an entraining time is 7:46, a departing station is Yuutenji, and a departing time is 7:55” can be output on the basis of a user operation. In addition, in an electric apparatus (for example, an external sound output apparatus or an external display apparatus) that is connected to the wireless communication apparatus, the association information may be output. In this case, the association information is transmitted from the wireless communication apparatus to an electronic apparatus and the association information is output from the electronic apparatus.

In the embodiments of the present disclosure, the examples of the integrally configured information processing apparatus (for example, the information processing apparatuses 210, 500, and 800) have been described. However, the embodiments of the present disclosure can be applied to an information processing system in which the case in which the individual units included in the information processing apparatus are configured by a plurality of apparatuses. For example, an information processing system (for example, cloud computing) existing on a network can be assumed. In addition, the embodiments of the present disclosure can be applied to a portable wireless communication apparatus (for example, an electronic apparatus including a wireless communication function (for example, a game machine, an electrical home appliance, a music reproducing apparatus, or a video processing apparatus) other than a mobile phone. In addition, the embodiments of the present disclosure can be applied to an electronic apparatus that can perform wireless communication by connection with other wireless communication apparatus.

It should be understood by those skilled in the art that various modifications, combinations, sub-combinations and alterations may occur depending on design requirements and other factors insofar as they are within the scope of the appended claims or the equivalents thereof.

The process sequences described in the embodiments may be handled as methods having a series of sequences or may be handled as programs for causing a computer to execute the series of sequences and recording media storing the programs. As the recording media, a hard disk, a compact disc (CD), a minidisc (MD), and a digital versatile disk (DVD) can be used. In addition, a memory card and a Blu-ray Disc (registered trademark) can be used.

Additionally, the present technology may also be configured as below.

(1) An information processing apparatus including:

a determining unit that determines a movement state of a wireless communication apparatus; and

a control unit that restricts a base station selection process of the wireless communication apparatus, based on the determined movement state.

(2) The information processing apparatus according to (1),

wherein the determining unit determines a type of a movement mechanism transporting the wireless communication apparatus, and

wherein the control unit restricts the base station selection process, based on the determined type of the movement mechanism.

(3) The information processing apparatus according to (2),

wherein the control unit restricts the base station selection process, only when the determined type of the movement mechanism is a high-speed movement mechanism.

(4) The information processing apparatus according to (3),

wherein the determining unit determines whether the high-speed movement mechanism is in a stop state, and

wherein the control unit does not restrict the base station selection process, when the high-speed movement mechanism is in a stop state even though the determined type of the movement mechanism is the high-speed movement mechanism.

(5) The information processing apparatus according to (4),

wherein the control unit restricts the base station selection process, when a connection state of a specific communication service at a position where the high-speed movement mechanism exists satisfies a predetermined condition even though the determined type of the movement mechanism is the high-speed movement mechanism and the high-speed movement mechanism is in a stop state.

(6) The information processing apparatus according to (2), further including:

a specifying unit that specifies a movement path of the wireless communication apparatus, based on position information regarding the wireless communication apparatus,

wherein the control unit restricts the base station selection process, based on the determined type of the movement mechanism and the specified movement path.

(7) The information processing apparatus according to (6),

wherein the control unit restricts the base station selection process, only when the determined type of the movement mechanism is a high-speed movement mechanism and a number of times of switching between different communication methods in the specified movement path is large based on a predetermined value.

(8) The information processing apparatus according to (3),

wherein the control unit does not restrict the base station selection process, when a specific communication service is provided in the high-speed movement mechanism even though the determined type of the movement mechanism is the high-speed movement mechanism.

(9) The information processing apparatus according to any one of (1) to (8),

wherein the control unit restricts each process regarding handover, cell selection, and cell reselection between different communication methods as the restriction of the base station selection process and executes only each process regarding handover, cell selection, and cell reselection between same communication methods.

(10) The information processing apparatus according to any one of (1) to (9),

wherein the control unit restricts switching from a communication method in which a cell size is large to a communication method in which a cell size is small as the restriction of the base station selection process and executes only each process regarding handover, cell selection, and cell reselection between same communication methods.

(11) An information processing apparatus includng:

a specifying unit that specifies a movement path of a wireless communication apparatus, based on position information regarding the wireless communication apparatus; and

a control unit that associates the specified movement path and the position information regarding the wireless communication apparatus in the specified movement path and displays an association result on the wireless communication apparatus.

(12) A communication system including:

an information processing apparatus that includes a determining unit that determines a movement state of a wireless communication apparatus and a control unit that performs control to restrict a base station selection process of the wireless communication apparatus, based on the determined movement state; and

a wireless communication apparatus in which the base station selection process is restricted based on control by the information processing apparatus.

(13) An information processing method including:

determining a movement state of a wireless communication apparatus; and

restricting a base station selection process of the wireless communication apparatus, based on the determined movement state.

(14) A program for causing a computer to execute:

determining a movement state of a wireless communication apparatus; and

restricting a base station selection process of the wireless communication apparatus, based on the determined movement state.

What is claimed is:

1. An information processing apparatus comprising:
a determining unit that determines a movement state of a wireless communication apparatus; and
a control unit that restricts a base station selection process of the wireless communication apparatus, based on the determined movement state.

2. The information processing apparatus according to claim 1,
wherein the determining unit determines a type of a movement mechanism transporting the wireless communication apparatus, and
wherein the control unit restricts the base station selection process, based on the determined type of the movement mechanism.

3. The information processing apparatus according to claim 2,
wherein the control unit restricts the base station selection process, only when the determined type of the movement mechanism is a high-speed movement mechanism.

4. The information processing apparatus according to claim 3,
wherein the determining unit determines whether the high-speed movement mechanism is in a stop state, and
wherein the control unit does not restrict the base station selection process, when the high-speed movement mechanism is in a stop state even though the determined type of the movement mechanism is the high-speed movement mechanism.

5. The information processing apparatus according to claim 4,
wherein the control unit restricts the base station selection process, when a connection state of a specific communication service at a position where the high-speed movement mechanism exists satisfies a predetermined condition even though the determined type of the movement mechanism is the high-speed movement mechanism and the high-speed movement mechanism is in a stop state.

6. The information processing apparatus according to claim 2, further comprising:
a specifying unit that specifies a movement path of the wireless communication apparatus, based on position information regarding the wireless communication apparatus,
wherein the control unit restricts the base station selection process, based on the determined type of the movement mechanism and the specified movement path.

7. The information processing apparatus according to claim 6,
wherein the control unit restricts the base station selection process, only when the determined type of the movement mechanism is a high-speed movement mechanism and a number of times of switching between different communication methods in the specified movement path is large based on a predetermined value.

8. The information processing apparatus according to claim 3,
wherein the control unit does not restrict the base station selection process, when a specific communication service is provided in the high-speed movement mechanism even though the determined type of the movement mechanism is the high-speed movement mechanism.

9. The information processing apparatus according to claim 1,
wherein the control unit restricts each process regarding handover, cell selection, and cell reselection between different communication methods as the restriction of the base station selection process and executes only each process regarding handover, cell selection, and cell reselection between same communication methods.

10. The information processing apparatus according to claim 1,
wherein the control unit restricts switching from a communication method in which a cell size is large to a communication method in which a cell size is small as the restriction of the base station selection process and executes only each process regarding handover, cell selection, and cell reselection between same communication methods.

11. An information processing apparatus comprising:
a specifying unit that specifies a movement path of a wireless communication apparatus, based on position information regarding the wireless communication apparatus; and
a control unit that associates the specified movement path and the position information regarding the wireless communication apparatus in the specified movement path and displays an association result on the wireless communication apparatus.

12. A communication system comprising:
an information processing apparatus that includes a determining unit that determines a movement state of a wireless communication apparatus and a control unit that performs control to restrict a base station selection process of the wireless communication apparatus, based on the determined movement state; and
a wireless communication apparatus in which the base station selection process is restricted based on control by the information processing apparatus.

13. An information processing method comprising:
determining a movement state of a wireless communication apparatus; and
restricting a base station selection process of the wireless communication apparatus, based on the determined movement state.

14. A program for causing a computer to execute:
determining a movement state of a wireless communication apparatus; and
restricting a base station selection process of the wireless communication apparatus, based on the determined movement state.
